(19) United States
(12) Patent Application Publication
(10) Pub. No.: US 2018/0011863 A1
(43) Pub. Date: Jan. 11, 2018

(54) GEO-BASED INFORMATION PROVISION, SEARCH AND ACCESS METHOD AND SOFTWARE SYSTEM

(71) Applicant: Cyberdor LLC, Cincinnati, OH (US)

(72) Inventors: Alfred X. Xin, Cincinnati, OH (US); Sherry Sun, Cincinnati, OH (US)

(21) Appl. No.: 15/710,955

(22) Filed: Sep. 21, 2017

Related U.S. Application Data
(63) Continuation-in-part of application No. 14/752,993, filed on Jun. 28, 2015, now abandoned.
Application No. 14/752,993 is a continuation of application No. 14/665,791, filed on Mar. 23, 2015, now abandoned.
Application No. 14/665,791 is a continuation of application No. 14/630,212, filed on Feb. 24, 2015, now abandoned.
Application No. 14/630,212 is a continuation of application No. 14/599,459, filed on Jan. 17, 2015.
Application No. 14/599,459 is a continuation of application No. 14/566,116, filed on Dec. 10, 2014.

(51) Int. Cl. G06F 17/30; H04W 4/18; G06Q 30/02; H04L 29/08; G06F 3/0484; H04W 4/20; H04W 4/02

(52) U.S. Cl. CPC G06F 17/3087; H04W 4/206; H04W 4/18; H04W 4/021; H04L 67/20; G06F 3/0484; G06Q 30/0267; G06Q 30/0261; G06Q 30/0257; G06Q 30/0277

(57) ABSTRACT

Method and system consist of a mobile application installed on a mobile device with internet connection and a geographical positioning device; a remote hosting server configured with software and database; an onsite wireless communication hosting apparatus. The mobile application communicates with the remote hosting server and the onsite wireless communication apparatus. The remote hosting server and onsite wireless communication apparatus communicate and transfer data to one another, the remote hosting server communicates with third party databases via secured access and retrieves location related information requested by onsite users of the mobile device. Web users at anywhere may select a location displayed on a digital map over interface of a web application configured to the remote hosting server; access the same information and multimedia programs as onsite users; including data entered by location owners, received from third-party databases via secured connection, and uploaded from onsite wireless communication apparatus.

### CROSS-REFERENCE TO RELATED APPLICATION

This application is a continuation-in-part of and claims the benefit of U.S. patent application Ser. No. 14/752,993, U.S. patent application Ser. No. 14/599,459, U.S. patent application Ser. No. 14/630,212, U.S. patent application Ser. No. 14/665,791, and U.S. patent application Ser. No. 14/566,116, the entireties of which are incorporated herein by reference.

### FIELD OF THE INVENTION

The present disclosure generally relates to systems, devices, and methods for targeted and location based communications for user devices, location based devices and web application.

### BACKGROUND OF THE INVENTION

Mobile device users go to visit places such as a business, a facility or an entity with a range of functions and capacities may not be aware of all the information, services, or accurate places of products and live or recorded information or programs provided in, at or close to those places. Therefore there is a need to provide them with automated system, and users don't have to do anything to have it activated and the system will show them what are offered at those places on popup windows above locked or unlocked screen of a mobile device: the system would automatically alert them and automatically displays static or live information and or performs multimedia programs, including but not limited to live or pre-recorded audio, and or visual programs. Web users at anywhere may select a location displayed on a digital map over interface of a web application configured to the remote hosting server; access information and multimedia programs as onsite users; including data entered by location owners and collected from other data resources, sent and uploaded from an onsite wireless communication apparatus.

### SUMMARY OF THE INVENTION

An onsite automated information search and multimedia method and system comprises of a software application installed on a mobile device with internet connection and a geographical positioning device; a remote server and database, and or an onsite wireless communication apparatus. Said software application communicates and transfers data with said remote server and said onsite wireless communication apparatus. When a user is in, at or close to a business, facility or an entity, and said software application finds said user is in, at or close to a location, via said geographical positioning device, with information stored in said database, or within a signal range of said onsite wireless communication apparatus, said software application automatically alerts said user and displays information, plays live or recorded multimedia programs from said business, facility or entity. Said remote server and said onsite wireless communication apparatus may communicate and transfer data to one another. Said remote server and said onsite wireless communication apparatus may also communicate and transfer data from a third-party database or webserver and forward said data to said software application. Said user may search specific information within or related to said business, facility or entity.

User, onsite and online, may search specific information within or related to said business, facility; or listen to and or watch live or recorded programs provided by said business, facility or entity. Information and multimedia programs from a third-party business, a facility or entity may be displayed on window and or played during information, and or live or recorded multimedia programs are shown by said business, facility or entity.

Said onsite wireless communication apparatus is configured for processing, creating forms of information and programs via graphical user interface, and publishing and broadcasting said information and programs. Said onsite wireless communication apparatus may communicate to one another either via said remote server or radio signals from one another within a range. Said onsite wireless communication apparatus may configure a number of wireless signal extenders as to expand signal-covering areas.

Said onsite wireless communication apparatus configured with multimedia devices as a portable, standalone and plug-and-play communication equipment and a core part of the entire architecture shall provide benefits for users from all walks of life (businesses, entertainment facilities, schools, small village or towns and etc. in the world) with wireless broadcasting means in their localities without having to upload and create information and programs to the internet first or build up a broadcasting tower, buy and install and configure complicated sets of equipment, users and or audiences of live programs and information may get direct access to said live or recorded programs and static or live information onsite either having or not having internet connections and cellphone signals with their mobile devices and said mobile devices extensions; and by configuring said onsite wireless communication apparatus with a set of wireless routers and or signal extenders, said users may be able to cover desired broadcasting range with a very little costs.

Not only said wireless communication apparatus benefits populations in developed communities, regions or countries, it shall greatly benefits undeveloped and geographically isolated places and would allow anyone like to have their own wireless communication system without having to build up a radio or TV station; Users of said equipment don't have to hire system administrators to configure and maintain a network configured with a number of hard and software systems, and there is no more need to make sure that all the hardware and software are compatible to one another; said equipment with assigned unique identification code allow them to connected to remote server and decide if they want to upload created information and or live or recorded programs with a few clicks from menu selections; and communication among said equipment and remote server enable information published and updated automatically with connections of geographical references without involving in IP address.

### DESCRIPTION OF THE DRAWINGS

Objects and advantages together with the operation of the present teachings may be better understood by reference to the following detailed description taken in connection with the following illustrations, wherein:

FIG. 1-A illustrates a flow chart that demonstrates logical flows of an onsite sales and commercial search method and system between onsite shoppers and a website with sales' commercials and coupons.

FIG. 2-A illustrates a display rendering a home screen of a cellphone with “Shopping Deals” button.

FIG. 2-B illustrates a display rendering first screen of said onsite sales and commercial search method and system with its market name.

FIG. 2-C illustrates a display rendering a flow map of mall displayed after a user selects “All Stores” button.

FIG. 2-D illustrates a display rendering deals from a store after said user selects a store from said map.

FIG. 2-E illustrates a display rendering deals with stores selling shoes within the mall.

FIG. 3-A illustrates a display rendering a home screen of a cellphone with “Shopping Deals” button. FIG. 3-B shows first screen of said onsite sales and commercial search method and system with its market name.

FIG. 3-C illustrates a display rendering a street map with store and business layouts after user selected “All Stores” button.

FIG. 3-D illustrates a display rendering deals from a store after said user selects a store from said street map.

FIG. 3-E illustrates a display rendering deals with stores selling shoes from stores displayed on said street map near said user.

FIG. 4-A illustrates a display rendering a home screen of a cellphone with “Shopping Deals” button.

FIG. 4-B illustrates a display rendering deals in a department store as user is in said department store.

FIG. 4-C illustrates an advertisement shown in a popup window as a user activated popup feature for showing onsite deals within a very close range.

FIG. 5 illustrates a flow chart that demonstrates logical flows of an automated onsite information search and multimedia method and system.

FIG. 6A illustrates a display rendering a specific position of a product located on store shelf in an aisle within a supermarket.

FIG. 6B illustrates a display rendering a visual program play on introduction of an onsite restaurant.

FIG. 6C illustrates a display rendering a screen of a cinema's information page with names of movies.

FIG. 7 illustrates a flowchart of said communication system.

FIG. 8 illustrates a flowchart of functional logics of said mobile application.

FIG. 9-A illustrates a data searching screen with a text entering box for online users to enter their searching area and or category.

FIG. 9-B illustrates a display rendering a digital map with drop down menu selections with different searching category, and selected location.

FIG. 10-A illustrates a display rendering a selected location displaying last page of information after a sequence of programs and information are shown.

FIG. 10-B illustrates a display rendering another location with live scenes in different sub-locations within a travel resort location.

FIG. 10-C illustrates a display rendering a supermarket published its updated information for the day with video recording clip and highlight sales and product location searching function.

FIG. 10-D illustrates a display rendering a message published by a community board member. To access information targeted to selected audiences or readers, secured access code is implemented in a public domain.

FIG. 11-A illustrates a display rendering a first screen of a mobile application of said system installed on a mobile device.

FIG. 11-B illustrates a display rendering a selection screen of said mobile application.

FIG. 11-C illustrates a display rendering an options of auto play or alert only.

FIG. 12-A illustrates a display rendering information or data shown from a location when a user with mobile device installed with mobile application of said system walk in a range of a location selected earlier.

FIG. 12-B illustrates a display rendering a simple map marked with interesting places within an ancient Greek town.

FIG. 12-C illustrates a display rendering a supermarket homepage with updated information for the day with video recording clip and highlight sales and product location searching function on a mobile device.

FIG. 12-D illustrates a display rendering a message published by a community board member. Community members receive messages once they are within a range of said community.

FIG. 13 illustrates a logic flow diagrams of mobile application.

FIG. 14A illustrates a display rendering a screen of cellphone displayed with said mobile application of said software system.

FIG. 14B shows a floor layout of department store with sections of merchandises locations and sales information.

FIG. 14C illustrates a display rendering information of a restaurant received by said mobile application of said software system when user of said mobile device is outside said restaurant.

FIG. 14D illustrates a display rendering a messages posted by customers about a restaurant.

FIG. 15A illustrates a display rendering a menu option allowing mobile user to communicate with a business outside of said business.

FIG. 15B is shown a list of movies shown in a cinema.

FIGS. 16-19 illustrate flow diagrams of an exemplary embodiment utilizing an OWCA to communicate with mobile devices.

FIG. 20 is an exemplary operatizing environment for OWCA communications.

FIG. 21 is an exemplary functional block diagram showing a structure for an OWCA.

FIG. 22 is an exemplary functional block diagram showing a system architecture of an OWCA.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

As used herein, the words “example” and “exemplary” mean an instance, or illustration. The words “example” or “exemplary” or terms of similar import do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

The terms “component,” “module,” “system,” “interface,” “platform,” “service,” “framework,” “connector,” “controller,” or the like are generally intended to refer to a computer-related entity. Such terms may refer to at least one of hardware, software, or software in execution. For example, a component may include a computer process running on a processor, a processor, a device, a process, a computer thread, or the like. In another aspect, such terms may include both an application running on a processor and a processor.

Moreover, terms such as “access point,” “server,” and the likes, are utilized interchangeably, and refer to a network component or appliance that serves and receives control data, voice, video, sound, or other data-stream or signaling-stream. Data and signaling streams may be packetized or frame-based flows. Furthermore, the terms “user,” “customer,” “consumer,” and the like are employed interchangeably throughout the subject specification, unless context suggests otherwise or warrants a particular distinction among the terms. It is noted that such terms may refer to human entities or automated components supported through artificial intelligence (e.g., a capacity to make inference).

A network typically includes a plurality of elements that host logic. In packet-based wide-area networks (WAN), servers (e.g., devices comprising logic) may be placed at different points on the network. Servers may communicate with other devices and/or databases. In another aspect, a server may provide access to a user account. The “user account” includes attributes for a particular user and commonly include a unique identifier (ID) associated with the user. The ID may be associated with a particular mobile device(s) owned by the user. The user account may also include information such as relationships with other users, application usage, location, personal settings, and other information.

Embodiments may utilize substantially any wired or wireless network. For instance, embodiments may utilize various radio access network (RAN), e.g., Wi-Fi, global system for mobile communications, universal mobile telecommunications systems, worldwide interoperability for microwave access, enhanced general packet radio service, third generation partnership project long-term evolution (3G LTE), fourth generation long-term evolution (4G LTE), third generation partnership project 2, BLUETOOTH®, ultra mobile broadband, high speed packet access, x^{th} generation long-term evolution, or another IEEE 802.XX technology. Furthermore, embodiments may utilize wired communications.

It is noted that, terms “user equipment,” “device,” “user equipment device,” “client,” and the like are utilized interchangeably in the subject application, unless context warrants particular distinction(s) among the terms. Such terms may refer to a network component(s) or appliance(s) that sends or receives data, voice, video, sound, or substantially any data-stream or signaling-stream to or from network components and/or other devices. By way of example, a user equipment device may comprise an electronic device capable of wirelessly sending and receiving data. A user equipment device may have a processor, a memory, a transceiver, an input, and an output. Examples of such devices include cellular telephones (e.g., smart phones), personal digital assistants (PDAs), portable computers, tablet computers (tablets), hand-held gaming counsels, wearables (e.g., smart watches), desktop computers, etc.

It is noted that user equipment devices can communicate with each other and with other elements via a network, for instance, a wireless network, or a wireline network. A “network” can include broadband wide-area networks such as cellular networks, local-area networks, wireless local-area networks (e.g., Wi-Fi), and personal area networks, such as near-field communication networks including BLUETOOTH®. Communication across a network may include packet-based communications, radio and frequency/amplitude modulations networks, and the likes. Communication may be enabled by hardware elements called “transceivers.” Transceivers may be configured for specific networks and a user equipment device may have any number of transceivers configured for various networks. For instance, a smart phone may include a cellular transceiver, a Wi-Fi transceiver, a BLUETOOTH® transceiver, or may be hardwired. In those embodiments in which it is hardwired, any appropriate kind or type of networking cables may be utilized. For example, USB cables, dedicated wires, coaxial cables, optical fiber cables, twisted pair cables, Ethernet, HDMI and the like.

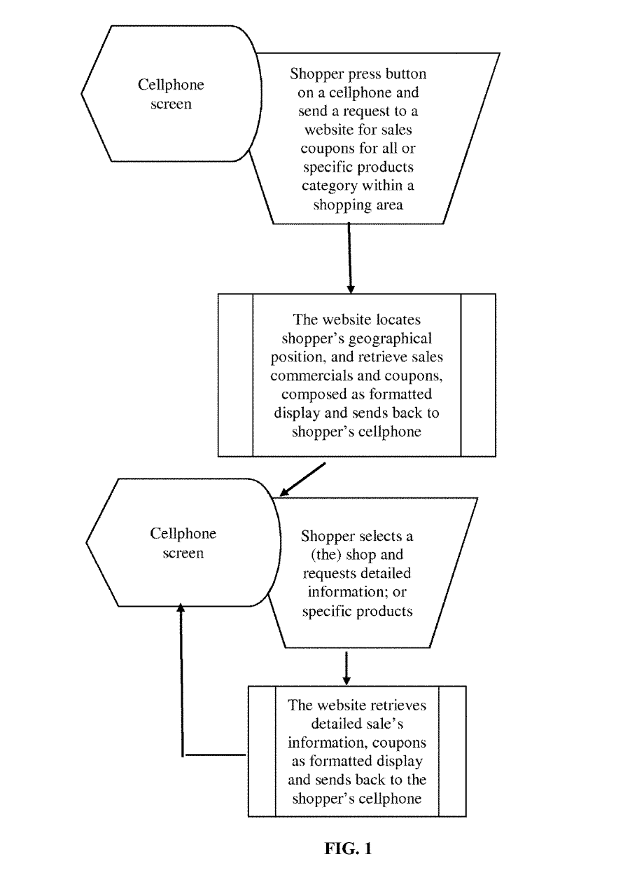

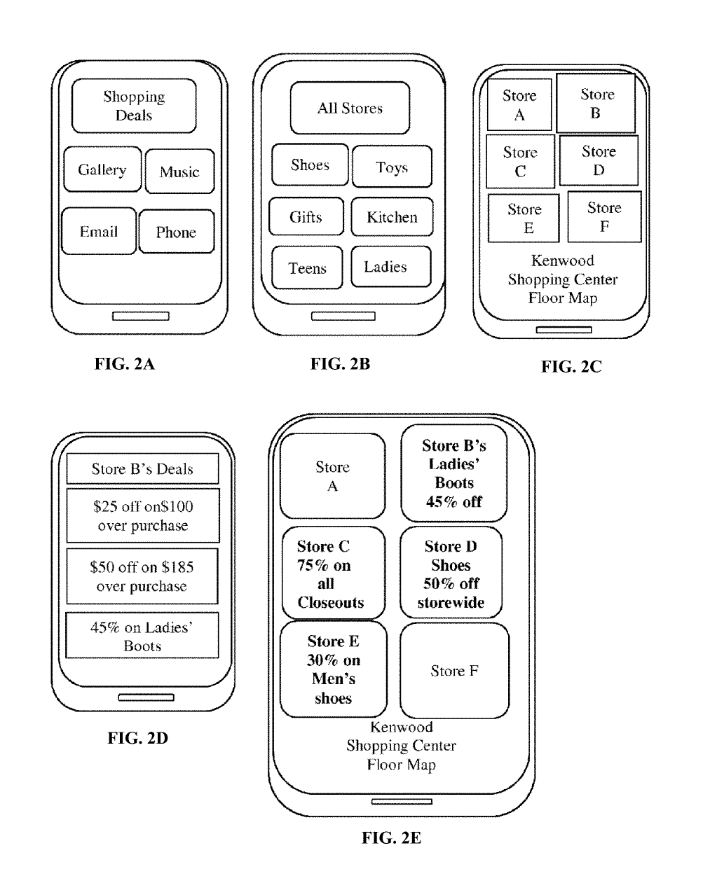

In a first embodiment, referencing to drawings, in FIG. 1 and FIG. 2 of a preferred embodiment of said automated onsite information search and multimedia system. A shopper is in a shopping mall area and has a cellphone installed with software of automated onsite information search and multimedia system displayed as “Shopping Deals”. Said shopper selects “Shopping Deals” button (FIG. 2A) on his cellphone and then selects “All Stores” button (FIG. 2B) in an attempt to get sales' information and discount coupons in the entire shopping mall area. Said software on said cellphone then sends a request on searching sales deals for the entire shopping mall area within said shopping mall.

Said cellphone receives all sales information from all the stores in said shopping mall from said software system's hosting web server and displays all the stores heighted that have sales offers (FIG. 2C) on a floor map on the screen of said cellphone.

Said shopper requests sales information from a store by touching said store's location and name on said floor map and the request is sent back to said software system's hosting web server. Said software system's hosting web server sends back entire available sales discounts offers posted by said store back to said cellphone and displays said commercial images on its screen (FIG. 2D).

Referencing to drawings, in FIG. 1 and FIG. 2 of another preferred embodiment of said automated onsite information search and multimedia system displayed on a cellphone as “Shopping Deals”. A shopper is in a shopping mall area and has a cellphone installed with said mobile application of said system connected to said software system's remote hosting server. Said shopper selects “Shopping Deals” button (FIG. 2A) on his cellphone and then selects “Shoes” button (FIG. 2B) selecting to get sales' information and discount coupons for a particular merchandise category. Said cellphone then sends a request on searching sales deals for the entire shopping area within said shopping mall to said software system's remote hosting server.

Said sales information on said merchandise category from all stores with said merchandise in said shopping mall are sent back with all sales offers by said stores to said cellphone and displayed on said cellphone with commercial images on its screen (FIG. 2E).

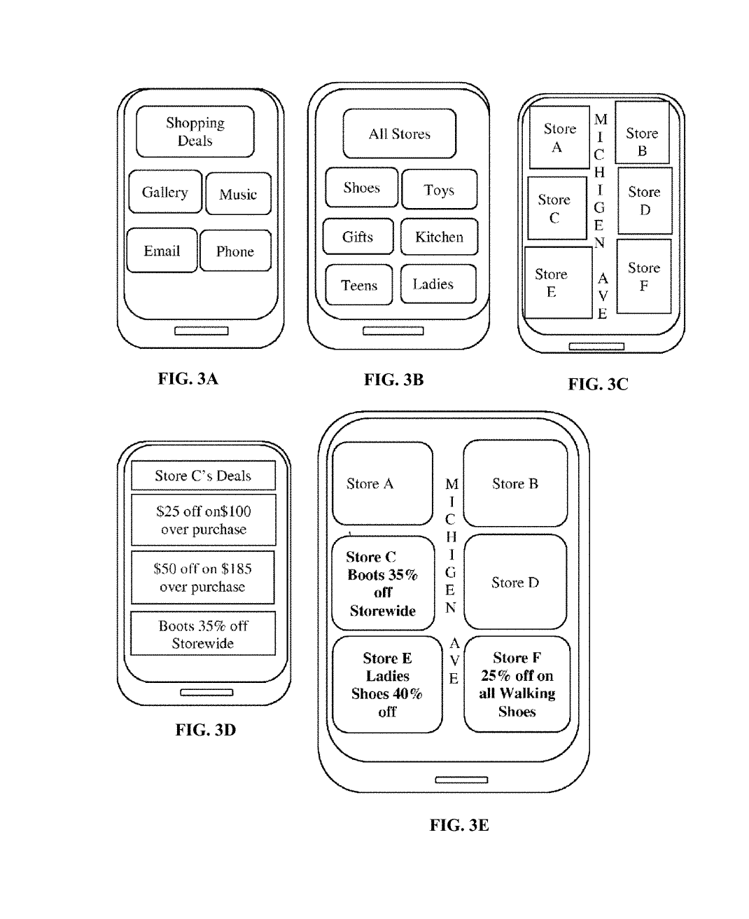

Referencing to drawings, in FIG. 1 and FIG. 3 of still another preferred embodiment of said automated onsite information search and multimedia system displayed as “Shopping Deals” on a cellphone screen. A shopper is in a shopping street area with said cellphone connected to internet and-said software system's remote hosting server. Said shopper selects “Shopping Deals” button (FIG. 3A) on his cellphone and then selects “All Stores” button (FIG. 3B) trying to get sales' information and discount coupons from stores within a range of said shopping area. Said cellphone then sends a request on searching sales deals for all stores within a range of said shoppers' physical position to said software system's remote hosting server.

Said mobile device receives all sales information from all the stores in a range of said shopper's physical position and displays an area map with all the stores heighted that have sales offers (FIG. 3C) on its screen.

Said shopper requests sales information from a store by touching said store's location on said onsite map and the request is forwarded to said software system's remote hosting server, said mobile device receives entire available sales discounts offers posted by said store from said website(s), and displays said commercial images on its screen (FIG. 3D).

Referencing to drawings, in FIG. 1 and FIG. 3 of still another preferred embodiment of said automated onsite information search and multimedia system. A shopper is in a shopping street area and has a cellphone connected to internet and said software system's remote hosting server. Said shopper selects “Shopping Deals” button (FIG. 3A) on his cellphone and then selects “Shoes” button (FIG. 3B) selecting to get sales' information and discount coupons for a particular merchandise category. Said cellphone then sends a request on searching sales deals for the entire shopping area within a range of said shoppers' physical position to web site(s).

Said mobile device receives all sales information on said merchandise category from all stores with said merchandise in said shopping street area and displays lists all sales offers with said commercial images on its screen (FIG. 3E).

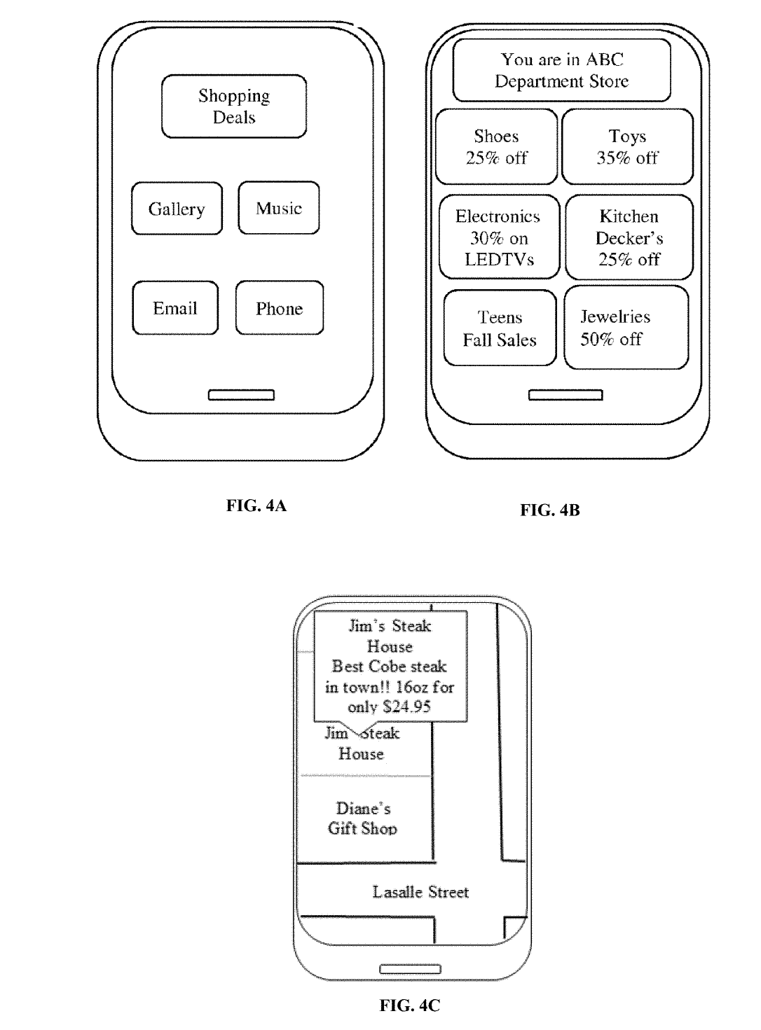

Referencing to drawings, in FIG. 1 and FIG. 4 of still another preferred embodiment of said automated onsite information search and multimedia system displayed on a cellphone as “Shopping Deals”. A shopper is in a department store and has said cellphone connected to internet. Said shopper selects “Shopping Deals” button (FIG. 4A) on his cellphone. Said software system communicates with said geographical positioning device and detects that said shopper is in a single unit commercial building at a postal address, and said cellphone then sends a request said remote hosting server and said software system configured with said remote hosting server receives said requests and checks from database of the system, data indicates that said system needs to communicate with computer system of said department store chain to retrieve most updated information from said computer system. Via secured connections said software system receives updated information from said computer system of said department store chain and forwards said information to said mobile application. Said cellphone receives all sales information on said department store and displays said commercial images on its screen (FIG. 4B).

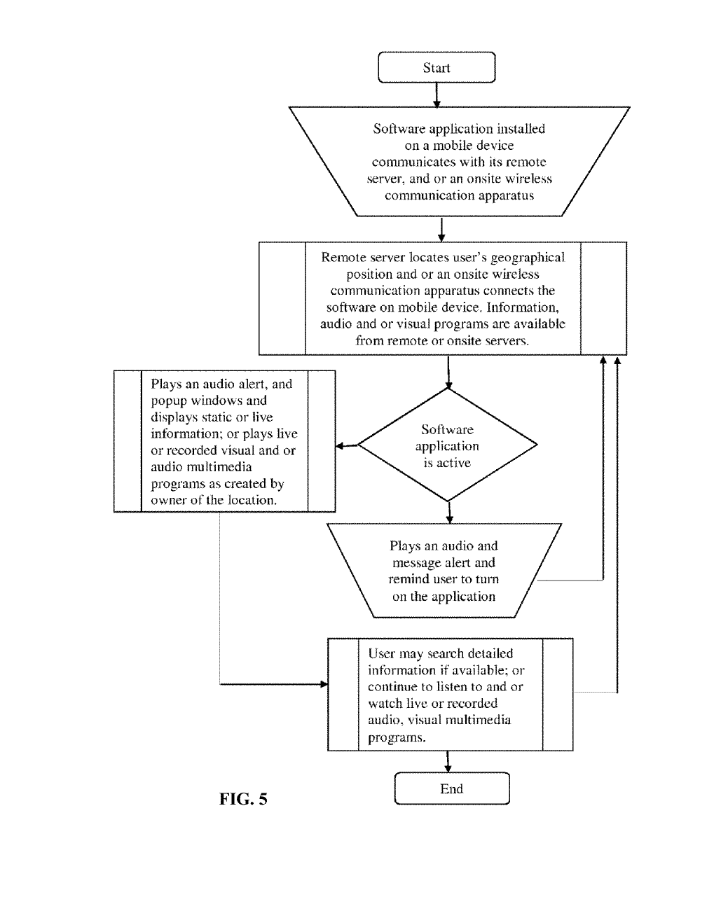

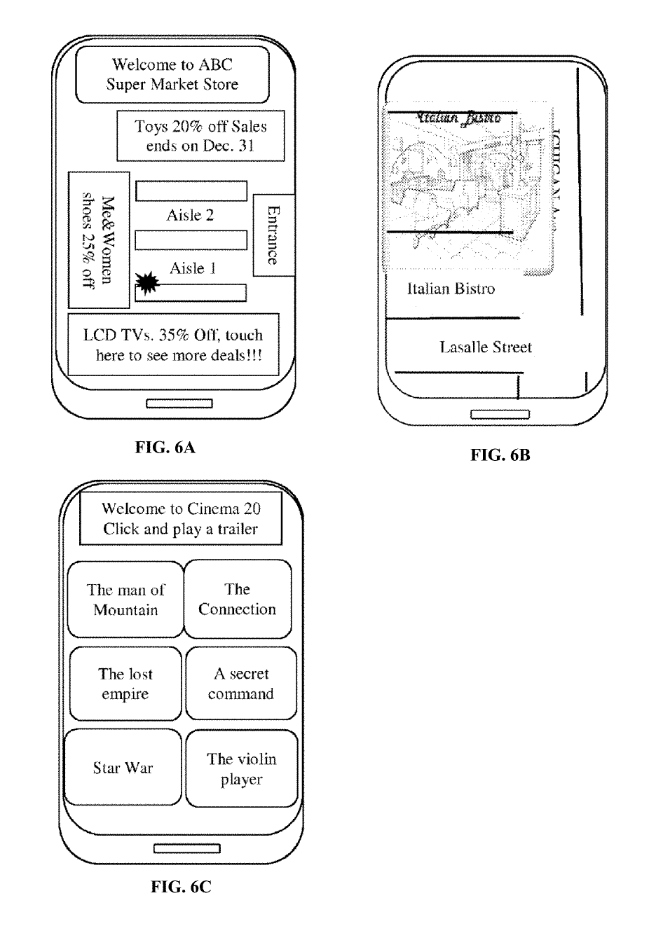

Turning now to FIGS. 5-6A-C, there is another embodiment Referencing to drawings in FIG. 5 and FIG. 6A, a preferred embodiment of said automated onsite information search and multimedia system. A user with a cellphone installed with software application of said automated onsite information search and multimedia system is in a supermarket, and said user's location is pinpointed by digital map and information and media program created by said supermarket is activated and forwarded to said cellphone from a remote server.

Said remote server automatically checks its database on said location and its identity, and finds said location is one of said locations registered with a national chain that runs a database and server. Said remote server is authorized by said national chain to allow direct and secured connection between said database and server of said national chain. Said remote server activates connection and sends said location code to said server of said national chain and said server of national chain searches its database and retrieve data related to said supermarket. Starting from this point and via said remote server, said database and server of said national chain and said software installed on said cellphone directly communicate and transfer data, commands and requests. All information and programs received on said software application installed on said cellphone are sent out from said database and server of said national chain via said remote sever of said automated onsite information search and multimedia system.

When said user enters said supermarket, said software application plays sound alert and gets attention of said user; a pre-recorded audio announces a welcome message and new products and good deals of said market for said day with location images; and also displays a text entering box allowing shoppers to search for specific product. Said user did not use text enter box, rather speaks to said microphone on said cellphone and looking for “ACB brand coffee”, said database and server of said national chain locates said product from its database and sends back information and flashing with “Star” sign on a place on a shelf in aisle 1. Said user directly goes to said place and picks up said product without wasting anytime.

As soon as said user leaves said location of said supermarket, said remote server cut off said connection between said database and server of said national, said software application is automatically closed on screen of said cellphone.

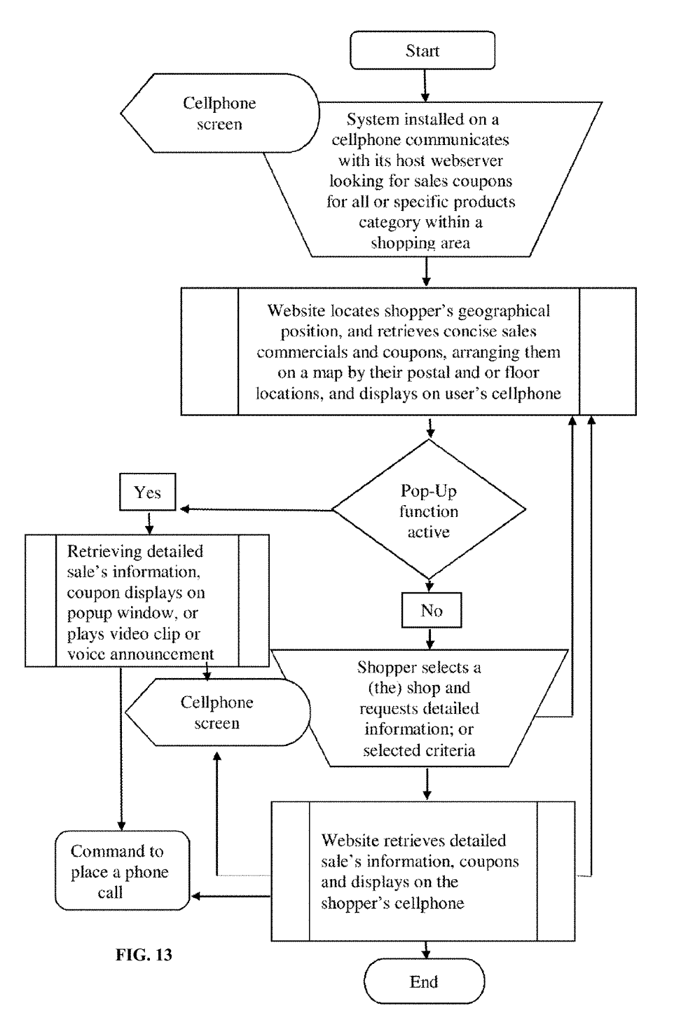

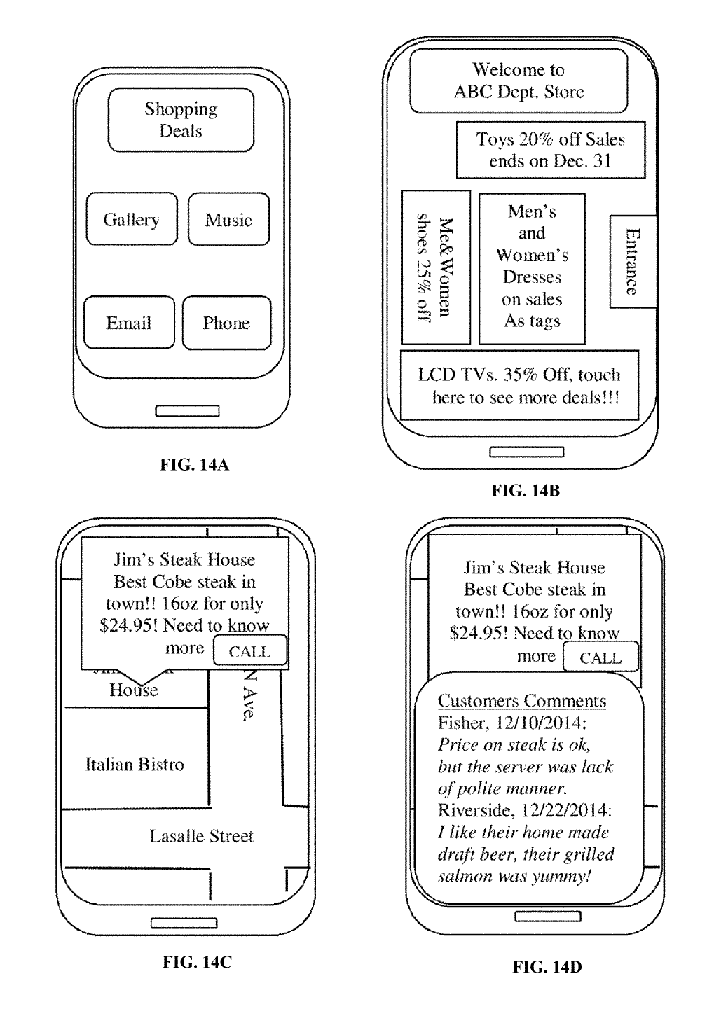

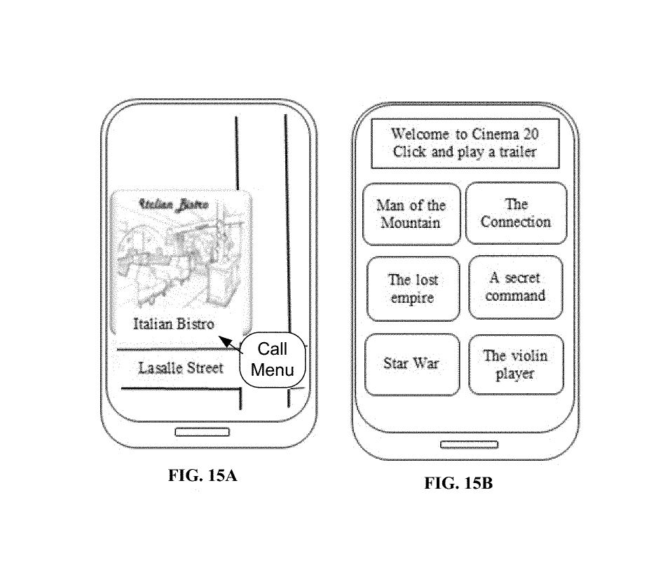

FIGS. 13, 14A-B, and 15A-B show an embodiment similar to those describe with references to FIGS. 1-4A-C where a hosting web server is utilized in place of a website. The software application communicates with its hosting web server, and the hosting server verifies location of the mobile device installed with GPS and mobile application of said software system and sends and displays information on a map or a floor layout on screen of the mobile device. When information is available, the system gives user audio and or visual signals and displays detailed information directly showing on a popup window with either static data, voice announcement or video clip. Shopper may also select to make a phone call even before get into the premises of a business.

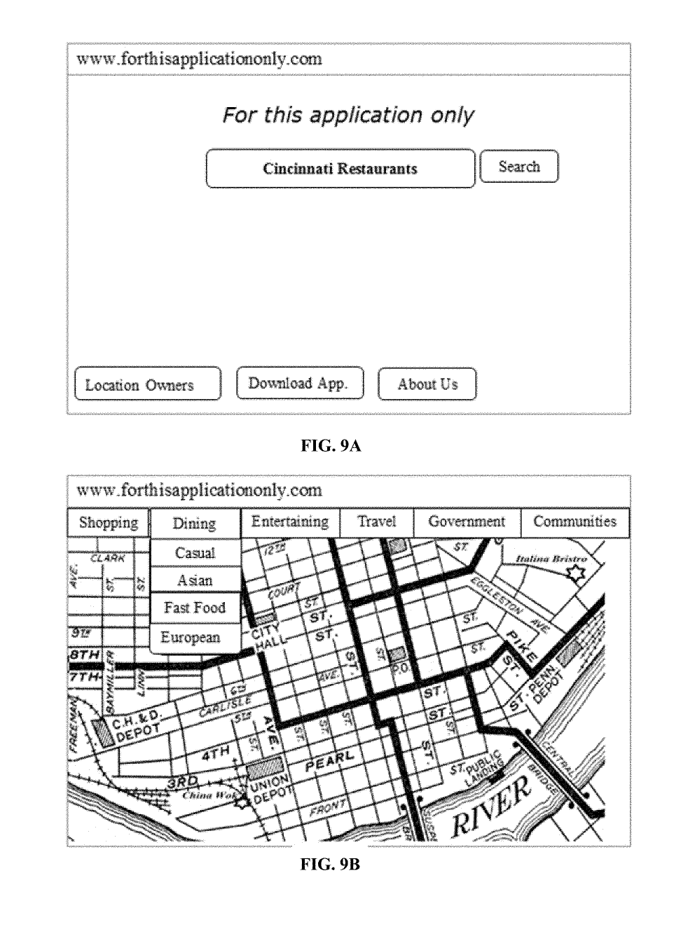

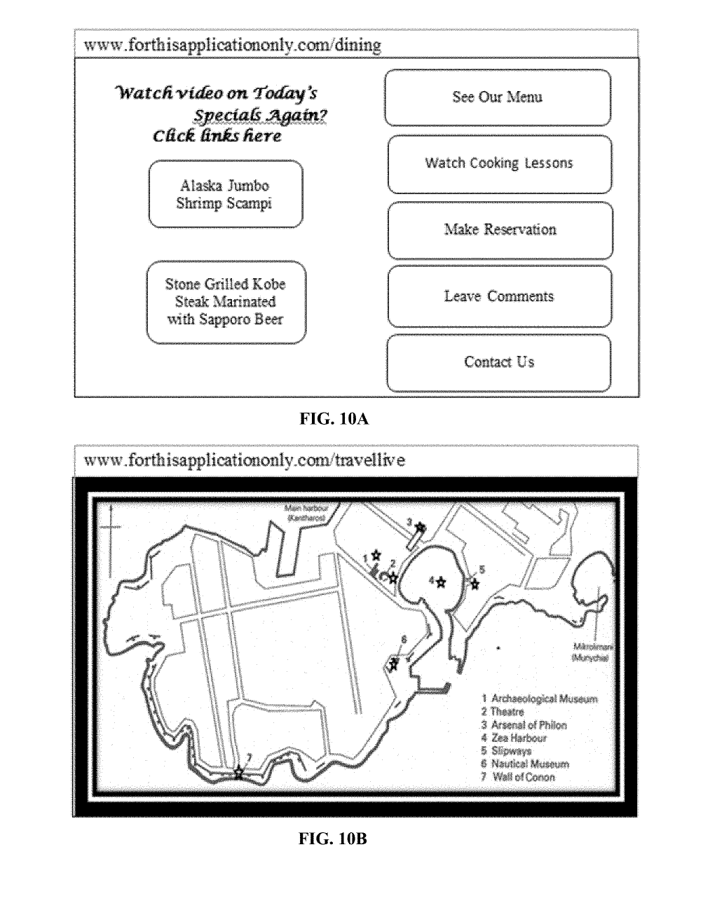

Referencing to drawings in FIG. 5, FIG. 6B, FIG. 9A-B of another preferred embodiment of said automated onsite information search and multimedia system. A user with a cellphone installed with mobile application of an automated onsite information search and multimedia system is outside of restaurant and read a menu board near its entrance. Said user's location is pinpointed by digital map and said software calculates that a timespan of the said user staying within a close range of said location is longer than 20 seconds and likely said user is interested in staying at said location and not a passerby, said software send its unique ID and location information to said remote server. Said remote server receives said information and, and then activates information and media program created by said restaurant forwards to said cellphone from a remote server.

Said software application plays sound alert and gets attention of said user; a recorded video clip, which was recorded by said restaurant owner with his cellphone and uploaded to said remote server, pops up on said cellphone screen and welcome said user and shows a brief introduction of said restaurant and also best sales dishes and best deals of said day; after said video play a menu displays on screen of said user's cellphone. A web user at home gets on a website, run by a web application configured with said remote server, and locates said restaurant on an interface of said web showing digital map by searching name of said business or related information. When said web user at clicks on location of said restaurant on said map, the same video greeting and the same information available for onsite visitors are also shown on said website.

Referencing to drawings in FIG. 5 and FIG. 6C of another preferred embodiment of said automated onsite information search and multimedia system. A user with a cellphone installed with software application of said automated onsite information search and multimedia system is inside of cinema and said user's location is pinpointed by digital map. Said remote server sends information and media programs created by said cinema to said cellphone.

Said software application plays a sound alert and gets attention of said user; a window page pops up with name of the movies shown on that day; an audio recording welcome said user and introduces said cinema briefly and asks said user to click on movie name and plays trailers of those movies.

Said administrators of remote server of said automated onsite information search and multimedia system created and inserts commercials and or information from third-party businesses and said commercials and information are displayed and or played during regular information and or programs to generate extra revenues for said cinema chains.

Referencing to drawings in FIG. 5 of another preferred embodiment of said automated onsite information search and multimedia system. A user with a cellphone installed with software application of said automated onsite information search and multimedia system is at a concert hall and sitting in a back row.

An onsite wireless communication apparatus is installed in said concert hall and wired with a sets of video cameras sends live video broadcasting of performances from stage to said cellphone, and it also temporarily has audio and phone reception functions of said cellphone disabled in order to make sure that no noises disrupt said performance. Even though said user sits far back in said concert hall, he can clearly watch said performances on said stage.

Referencing to drawings in FIG. 5 of another preferred embodiment of said automated onsite information search and multimedia system. A user with a cellphone installed with software application of an automated onsite information search and multimedia system is in football stadium sitting in a back row, and said user paid a fraction of price and bought a permit to watch onsite live video broadcasting.

An onsite wireless communication apparatus is wired with a sets of video cameras sends live visual broadcasting of the game. Said software application installed on said cellphone receives signals of a unique identification code of said onsite wireless communication apparatus and forwards said signals to a remote server for verification and make sure if said onsite wireless communication apparatus is licensed and authorized for live video broadcasting by said remote server.

After said remote server sends an approval signal to said software application installed on said cellphone, said software application opens a login window and asking said user to enter his permit number printed on his ticket. After said user enters its permit number, said software starts to receive and show live video broadcasting from said onsite wireless communication apparatus. Even though said user sits a back row of said stadium, he can clearly watch said match in the field. During breaks of said match, commercials and or information of any third-party are shown on said software application.

Said onsite wireless communication apparatus is connected to said remote server and transferring onsite information and live visual program to said remote server. Said remote sever transfers said onsite information and live visual program to its website, and also to said software application installed on said mobile device. Users of said software application from different places may select said information and live program from said remote information and program menu option, pay a fee and read said information and watch said live game; other audiences may also pay a fee and read and watch said same on other mobile devices, computers and TVs with internet connections.

Referencing to drawings in FIG. 5 of another preferred embodiment of said automated onsite information search and multimedia system. A user with a cellphone installed with software application of an automated onsite information search and multimedia system gets in a resort town with no knowledge where to go.

An onsite wireless communication apparatus located in said town center sends welcome video to said cellphone, briefly introduces said town and then display a map of said town on a window. Said user clicks on interesting places shown on said map and get detailed information about those places with static information and or recorded video clips.

Referencing to drawings in FIG. 5 of another preferred embodiment of said automated onsite information search and multimedia system. A user with a cellphone installed with software application of an automated onsite information search and multimedia system is at an airport and trying to find information and routing to get to his flight.

An onsite wireless communication apparatus located at said airport sends welcome video to said cellphone, briefly introduces said airport structures and then asks said user to enter his flight information by rather typing into a text box on said welcome window, or give an oral command; said user speaks his flight number, said onsite wireless communication apparatus retrieves and displays flight information and boarding location from a database and drawing a map routing map for said user based on his location and leading his way to said boarding terminal, and also constantly updating flight information with streaming data shown on window.

Referencing to drawings in FIG. 5 of another preferred embodiment of said automated onsite information search and multimedia system. A user with a cellphone installed with software application of an automated onsite information search and multimedia system is in a mountain with a group of campers and without cellphone signal, and said user gets lost in said wood.

Fortunately said organizer of said travel group brings an onsite wireless communication apparatus and published camp location on a map and all important information on said application window, and also live video onsite of said camp is broadcasted. Said user looks at said software application on said cellphone, it shows where said camp center is and routes to get back to said camp center and also hears that said other member of said group talking to him over said speaker and encourage him to come back soon before it gets dark.

Referencing to drawings in FIG. 5 of another preferred embodiment of said automated onsite information search and multimedia system. A small village or small town located in remote African place without internet and cellphone signals installed a unit of onsite wireless communication apparatus (OWCA), said onsite communication apparatus installed with a software package with GUI and is configured to allow users of OWCA to enter and publish information, broadcast live or load recorded multimedia programs. Instead of building up a radio or a TV station, said small village or small town publishes information about said places and updates news, provide people with mobile devices installed with said mobile application of said software system in said places with information, live and recorded audio and video broadcasting when needed.

When any information and or programs are available or updated, people in said places with their cellphones installed with software application of an automated onsite information search and multimedia system will be alerted with a special ringtone and updated information and or programs are automatically shown above either locked or unlocked screens of said cellphones.

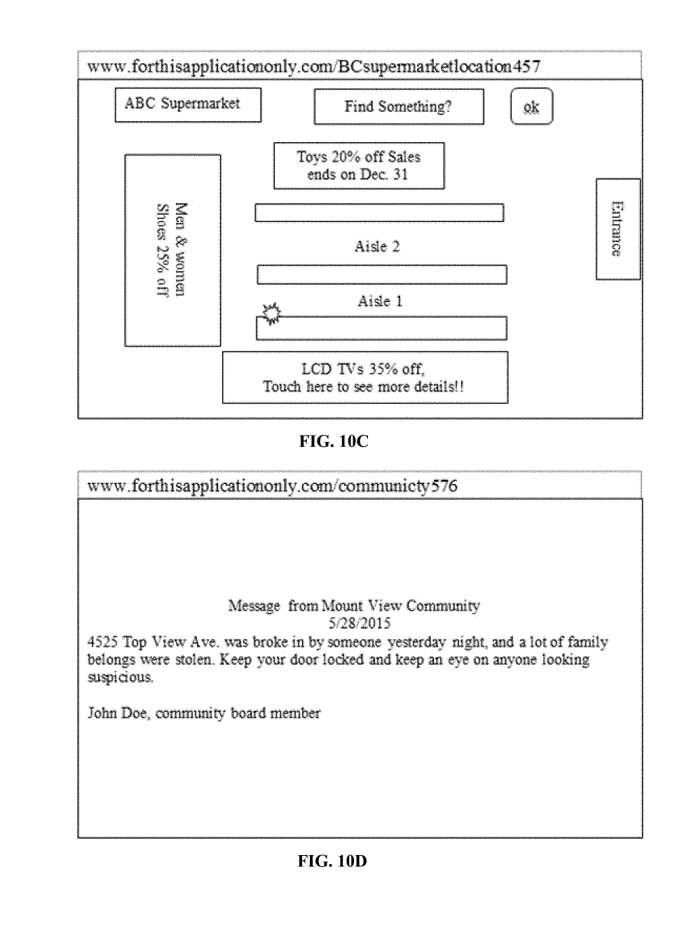

Referencing to drawings in FIG. 10-C, another preferred embodiment of said automated onsite information search and multimedia system. An online user selects a supermarket location from digital map shown on said software system. Said system finds said location belongs to a nationwide supermarket chain, said system then connects and requests data related to said supermarket to computer system of said nationwide supermarket chain with a code assigned for said supermarket, and start from this point, related information and data from database of said nationwide supermarket chain sends to said software system and then said software system forwards and further displays said information and data on said online user's computer over web interface of said website of said software system.

A video clip is shown up on a window with greeting from a supermarket staff, and then she briefly introduces what are the hot sales and new products of the day; a floor layout map with highlighted items marked in different section is followed.

A text box with “Find Something?” at the top of the screen. Users may type or give oral commands via a microphone connected to his computer and search for specific location of a product marked on said floor layout map and shelves. Said online user selects products he would like to buy and put them in online shopping cart, checks them out and have them shipped to his door.

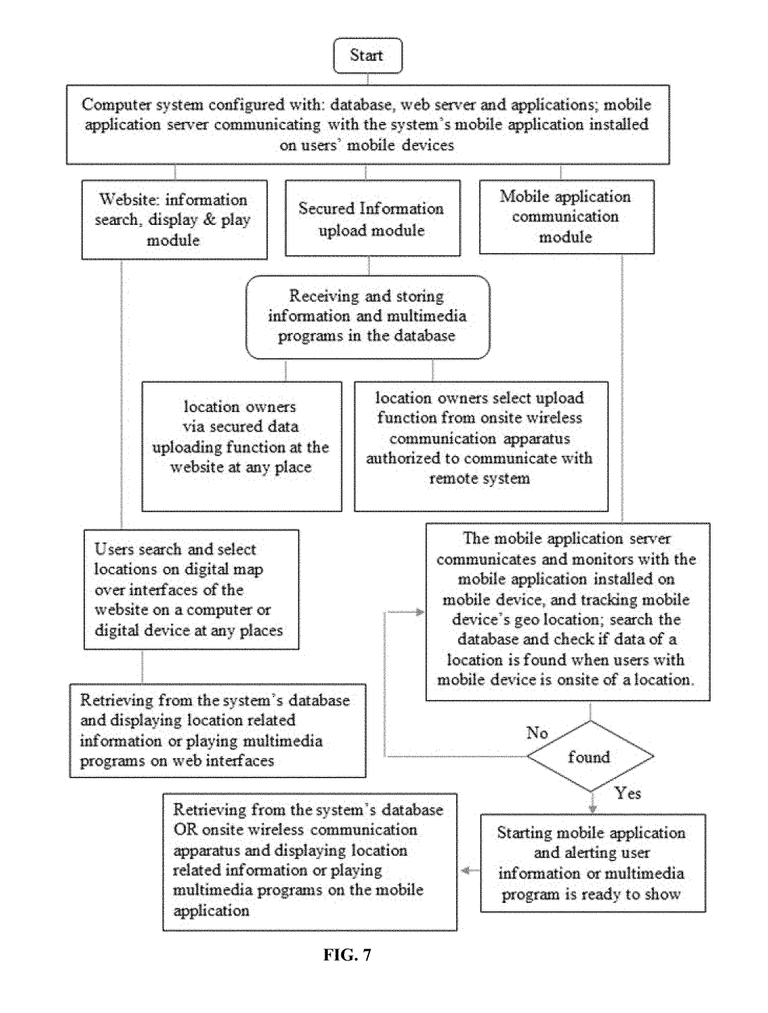

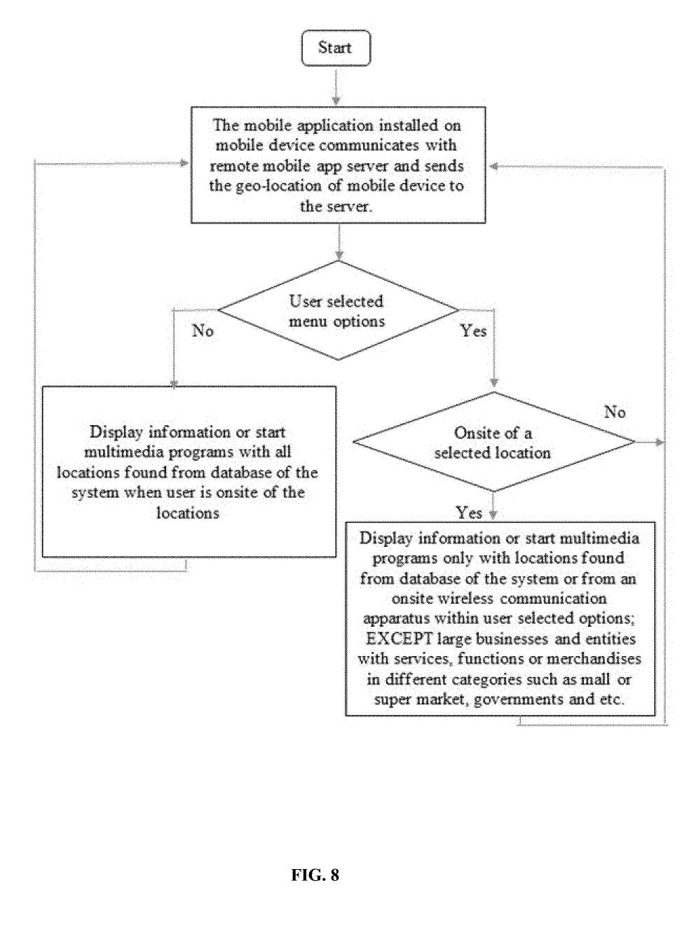

Referencing to drawings in FIG. 7 and FIG. 10-D, another preferred embodiment of said automated onsite information search and multimedia system. A resident of a community is out of town. He wants to know anything happening at home, and he gets on said website of said system, and finds location of his community. He clicks on the location and a small secured logon window appeared, he types in password shared by all residents of his community, a newly posted message shown up on said window, and he gets the most updated information back home.

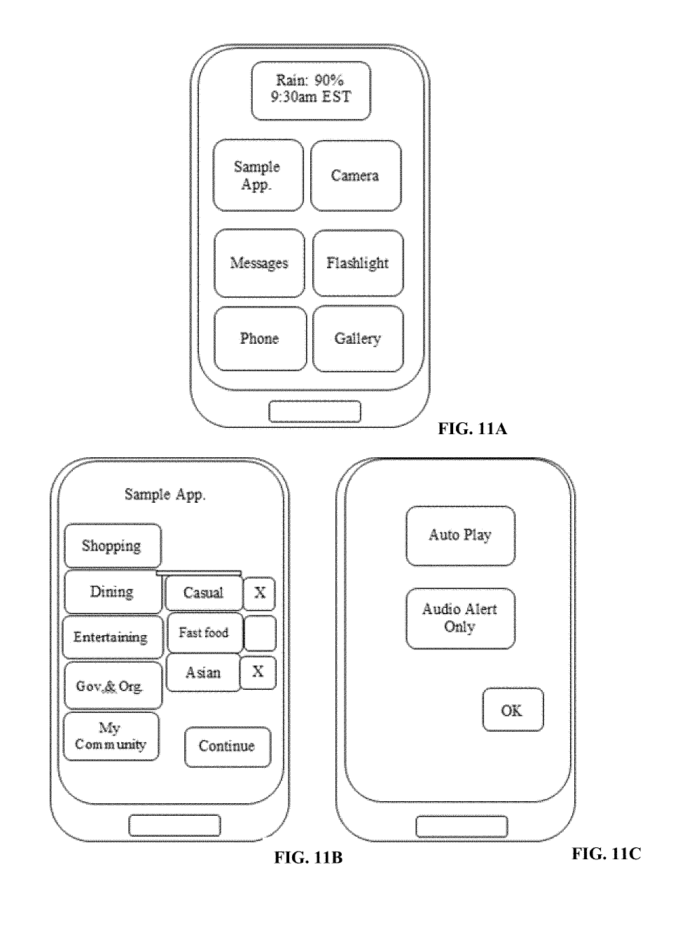

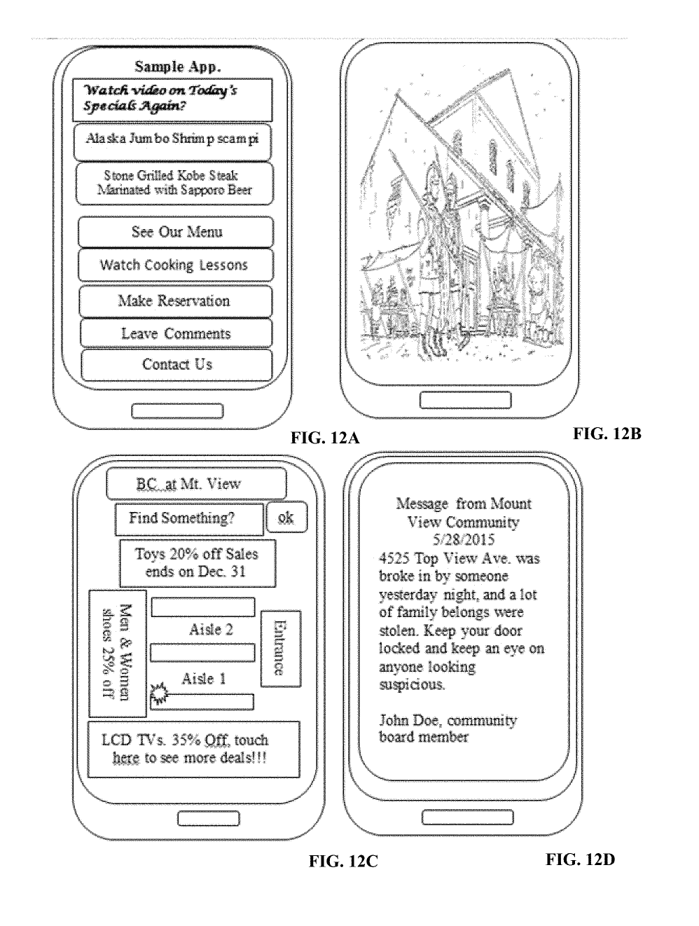

Referencing to drawings in FIGS. 7-8 and FIG. 12-B, another preferred embodiment of said automated onsite information search and multimedia system. A traveler with a mobile device installed with mobile application of said system visits an ancient Greek town.

Said system monitors geo-location of said mobile device installed with mobile application of said system and geo-location tracking device. As said traveler enters said Greek town, a recorded video clip pops up on his mobile device broadcasted by an onsite wireless communication apparatus located within said town, greeted him with brief introduction of the town. Then a very simple map marked with interests points are shown on said mobile device. Said traveler touches those interesting points on said map, live videos are broadcasted to show scenes of the places. Said traveler plans to visits only very interesting places and arranges a short cuts to get to those places even before starts his trip.

When said traveler walks through different places, a recorded video demonstrating live scenes and daily life of said town people is shown on said software application installed on said mobile device accompanied with narrations. As selections setup by owner of said Greek town travel resort on said website, said owner intends to run some more valuable videos for onsite visitors with paid admissions only.

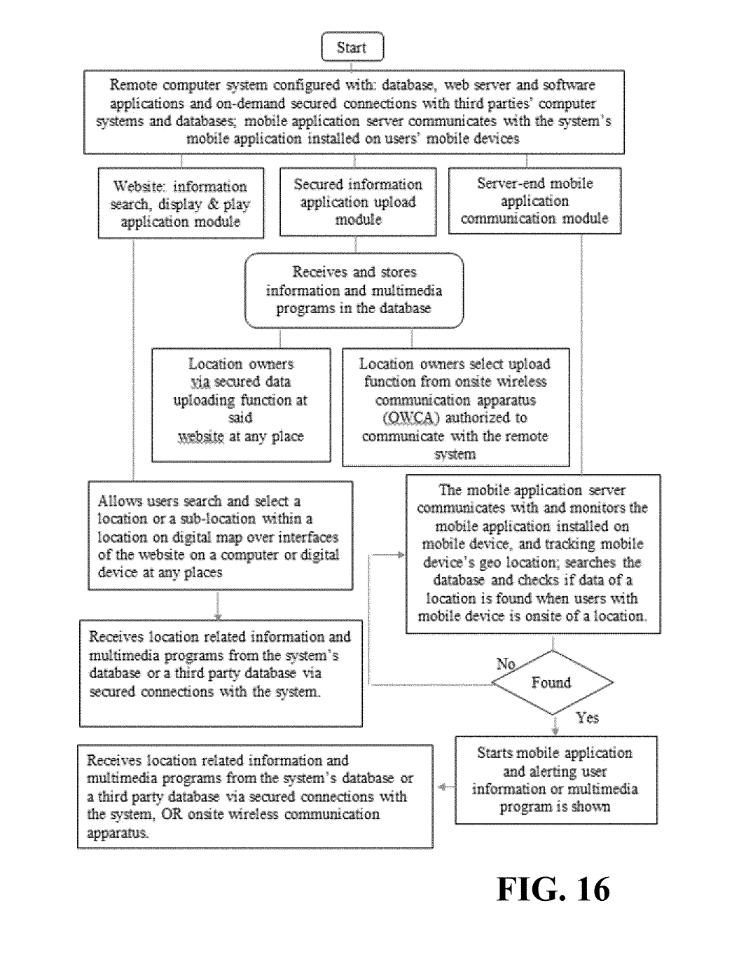

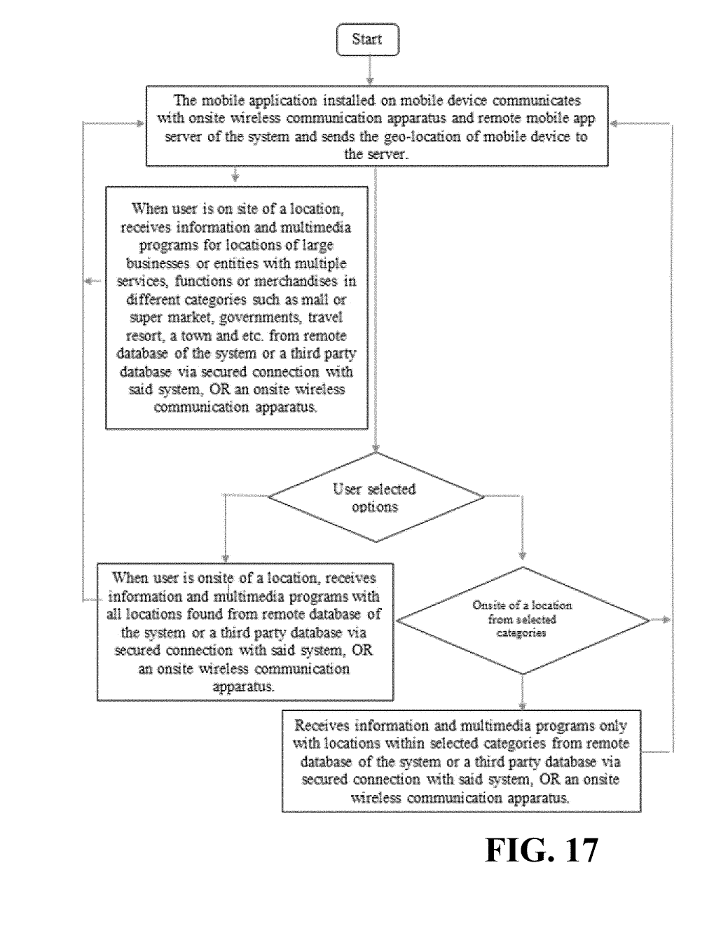

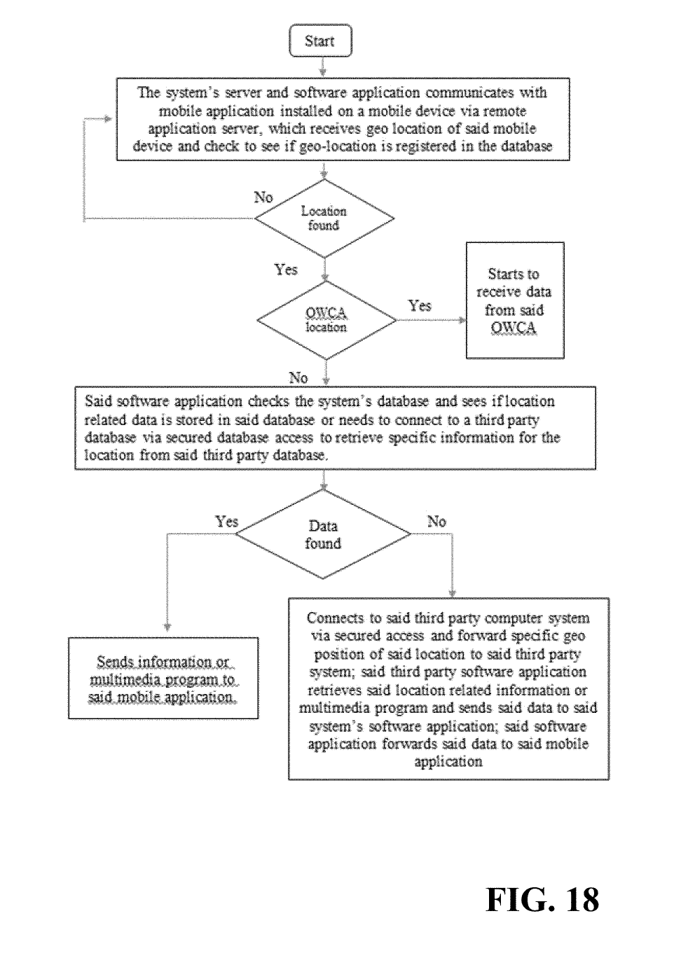

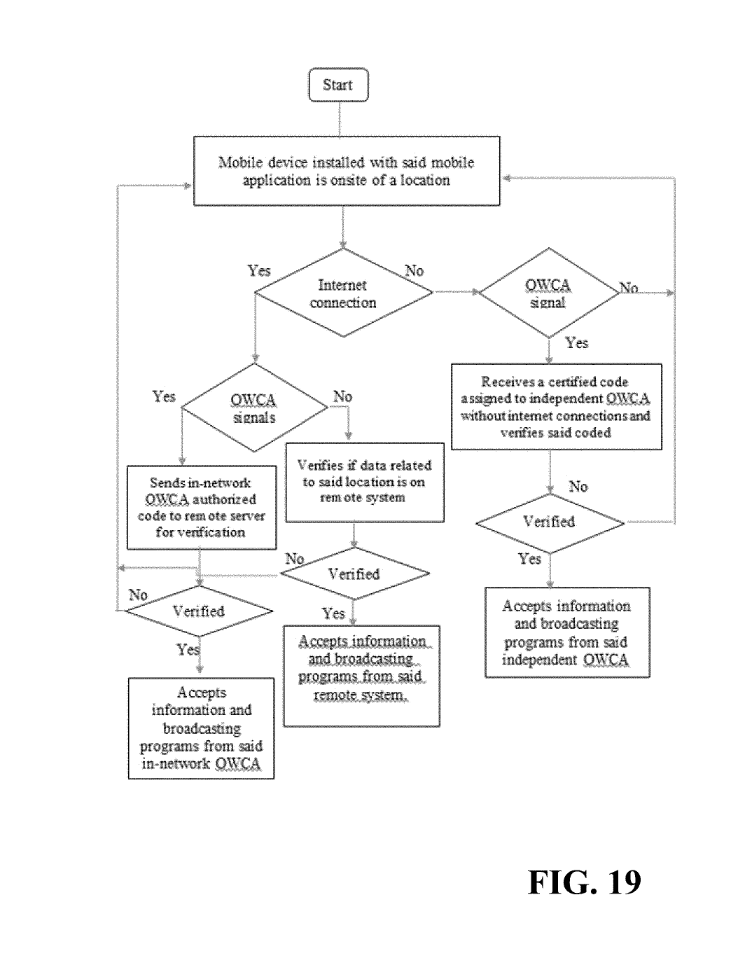

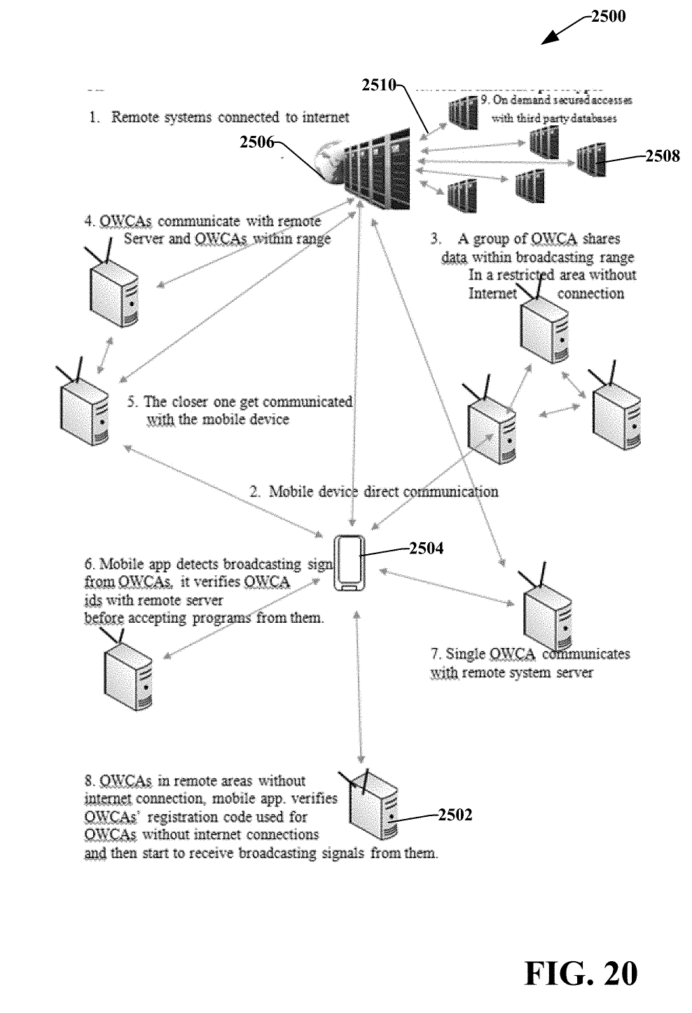

Turning now to FIGS. 16-22, described are embodiments of a computerized off-site and onsite synchronized information portal system 2500 of FIG. 19 that may primarily comprise of database, web server 2506 and website applications; software applications connected to third party servers and database 2508 via secured connections 2510, onsite wireless communication apparatus (OWCA 2502) 2502; mobile application server and mobile application installed on users' mobile devices 2504. The flow charts of FIGS. 16-19 generally describe algorithms used by the various system components 2502, 2504, 2506, 2508, and 2510 of FIG. 20. It is noted that various embodiments disclosed above may also utilize the system components of FIG. 20.

Location owners, as described herein, may upload data via secured data uploading function on said web server 2506 and website applications at any geographical location. In an embodiment, the owners with an OWCA 2502 authorized to communicate with remote systems may select an upload data function to upload data to remote server 2506, and activate onsite broadcasting function.

Said web server 2506 and website applications are configured to provide online users with search and selection functions on locations over digital map on interfaces of said website on a computer or mobile device 2504 at any places; the system retrieves data related to said selected location from database of said system, location and sub-locations related information or multimedia programs are shown on said web interfaces of the computer or mobile device 2504.

Said mobile application server communicates with and monitors said mobile application installed on the mobile device 2504. In another aspect, the mobile application server tracks the mobile device 2504's geo location based on GPS signals, OWCA signals, wireless signals from data points, user entered information, or the like. It is noted that any method of location tracking may be utilized.

The mobile application server may search said database 2510 and checks if a location is associated with an entry in the database based on the identified geolocation. In another aspect, the mobile device 2504 may communicate directly with an OWCA for location information and to establish a connection. Once a location is found within user selected options, the mobile device 2504 may show information or multimedia programs based on data received from an OWCA 2502, or information received through the web server 2506. In an aspect, the mobile application may allow a user to select an option to automatically generate an alert when such information is available and/or received. In another aspect, the mobile device 2504 may only communicate with the OWCA 2502 when the mobile device 2504 is within a geographic area of the OWCA 2502. This may establish secure connections and, in addition, may reduce data consumption of a user of the mobile device 2504 as the mobile device 2504 need not communicate via a wireless service provider.

Said mobile application on said mobile device 2504 may be configured to allow users to select interested categories and sub-categories of locations before start his or her route. The categories may be stored in a memory of the mobile device 2504. In another aspect, the mobile device 2504 may automatically select categories based on user selected criteria, use history, past user likes, information received from third party services (e.g., social media, etc.), or the like. In an example, a user may not select any options from said mobile application menu, and the mobile device 2504 may display information or multimedia programs of all places found from said database of said remote system or said onsite wireless communication apparatus.

In another embodiment, information and multimedia programs of large businesses and entities with multiple services, functions or merchandises may be identified in different categories such as mall or super market, government bodies are shown at all time regardless of whether menu options selected by said mobile users. This may allow larger entities to show a number of different options to a user.

Location owners have options to get on said website at any places, or their onsite wireless communication apparatus, to create secured accounts, register their geographical locations or postal addresses, nature and functions of the locations along with other information; select functions and features available within their accounts and publish their information, connect video or audio equipment to said OWCA 2502 for live broadcasting or upload recorded audio and video recordings; select sequences of presenting said information, data and or recorded or live programs. In an aspect, the location owners may have accounts registered with a service provider. The location owners may rent, buy, or otherwise receive OWCA's 2502 from the service provide.

Once they are registered with geographical locations or postal addresses and select to publish their information or data, their geo-position will be: a. marked with an image showing the nature or functions of the place along with name of their business, facilities, entities, government bodies or organizations on a digital map of said website; b. associated with mobile device users having said mobile application and physically within a range of the geo-position. The location owner may select and/or edit the image, information, or other associated information. It is further noted that the location owner may view the mobile device's 2504 within range of their OWCA 2502. It is further noted that the location owner may black/white list certain mobile devices 2504. For instance, if a mobile device 2504 is associated with suspicious or undesirable activity, the location owner may select to disable the connection of the OWCA 2502 and the mobile device 2504.

Said system's remote server and database 2506 may be communicating via secured connections with remote server and database of third parties 2508. A user may access a location on a digital maple from an online connection and/from a mobile device 2504. When the location is selected or a user with mobile device installed with mobile application of said system is onsite of a location, the database 2506 may query entries to search for and identify entries associated with the location. For instance, the database 2506 may identify a store with a registered account in the vicinity of the mobile device 2504. In another aspect, the database 2506 may query the third party database 2508 via a secured connection 2510. The database 2506 may receive information via the secure access 2510 from the third party 2508. This may allow the system 2500 to have a closed or otherwise secured connection. As such, OWCA's 2502 may maintain a secure connection for mobile device 2504. This may allow the location owners to send most updated and specific information of the said location to said mobile users and also to connect with users without the users worrying about unwanted attacks from hackers or the like.

In another aspect, the OWCA's and/or remote server 2506 may transmit information (e.g., multimedia programing, advertisements, etc.) via a web interface for online users. For users accessing a OWCA 2502, the mobile device 2504 may generate a notification that the information is available. In some embodiments, the mobile device 2504 may automatically display the information with notifying the user.

OWCA's 2502 may be configured to connect to said remote server 2506 of said system 2500 via internet connection, as described herein. In another aspect, OWCA's 2502 may operatively communicate with other OWCA's 2502. For instance, a large location (e.g., mall, office building, stadium, etc.) may utilize multiple OWCA's 2502 to cover a large geographic area. In this instance, OWCA's 2502 may communicate with each other or with a central OWCA 2502 that may, in turn, communicate with the remote server 2506. It is noted however, that each OWCA 2502 may communicate with the remote server 2506 and/or may selectively disable or prevent communication with the remote server 2506.

A user of a mobile device 2504 installed with said mobile application may be within a location where there is no OWCA 2502 or an OWCA 2502 has malfunctioned. As such, the mobile device 2504 may communicate directly with the remote server 2506. Once a OWCA 2502 is identified or otherwise properly functioning, the mobile device 2504 may terminate connection with the remote server 2506 and may communicate directly with the OWCA 2502. It is noted, however, that the mobile device 2504 may continue to communicate with the remote server 2506 as well as the OWCA 2502. For instance, the OWCA 2502 may provide location specific information, high-bandwidth information, or the like, while the remote sever 2506 may provide general information (e.g., a map of a larger region), low bandwidth information, etc.

In at least one embodiment, the system 2500 may require the OWCA 2502 to register with the remote server 2506 to enable access or communication with the mobile device 2504. According to one embodiment, the mobile device 2504 may request an identification code from the OWCA 2502. The mobile device 2504 may forward the identification code to the remote server 2506 for verification. The remote server 2506 determines whether or not to verify the OWCA 2502 and may forward the information to the mobile device 2504.

In at least one embodiment, an OWCA 2502 may be associate with a rating or classification. For instance, an OWCA 2502 may be associate with adult content, a particular type of food, a secured environment or the like. When the remote database 2506 receives the verification code, it may cross-reference user settings and the OWCA 2502 classification. If, for example, the mobile device 2504 has enabled parental controls, the remote database 2506 may prevent the OWCA 2502 classified for adult content from communicating with the mobile device 2504. In another example, the OWCA 2502 may associate with food containing allergies (e.g., nuts). The remote database 2506 may cross-reference user settings identifying the allergies and may notify the user via the mobile device 2504 when the user is identified as allergic to the particular allergen. These, of course, are merely examples of possible communications. As such, this disclosure is not limited to such.

It is noted that the remote database 2506 may be off or otherwise not available in a particular area or to a particular mobile device 2504. In such embodiments, OWCA 2502 may communicate with the mobile device 2504 directly for verification. A user may manual verify an OWCA 2502, such as through an on-screen prompt. In another aspect, the mobile application may check said OWCA 2502 identification number against identification numbers stored with said mobile application which are assigned to those OWCA's 2502 in the areas or regions which have no internet or cellphone signals, once verified said mobile application may receive information and multimedia programs broadcasted from said OWCA's 2502. It is noted that the mobile application may store a list of pre-registered or previously visited OWCA's 2502. Moreover, a user may selectively remove an OWCA 2502 from a pre-registered list.

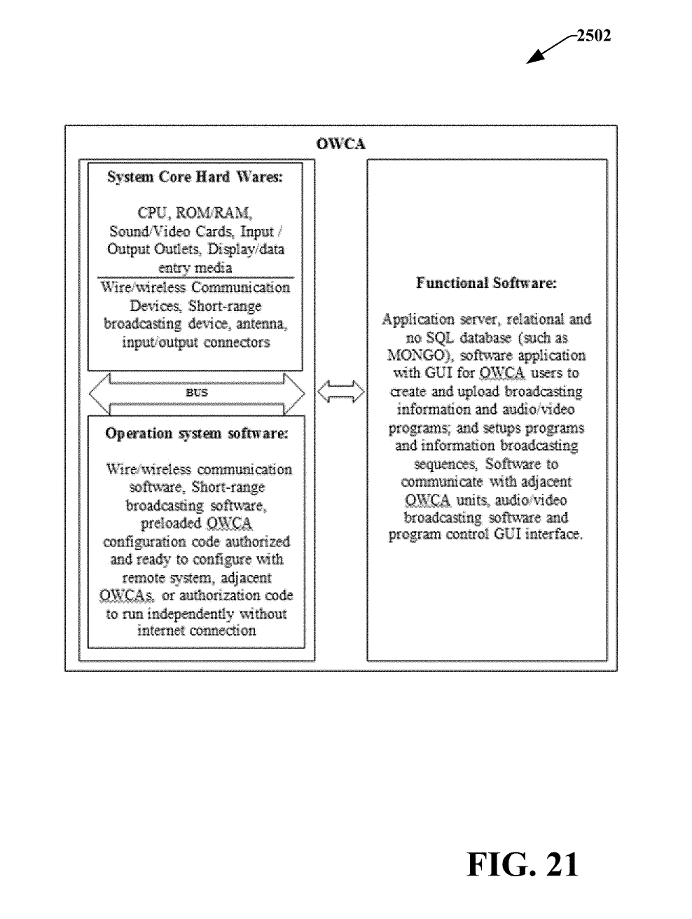

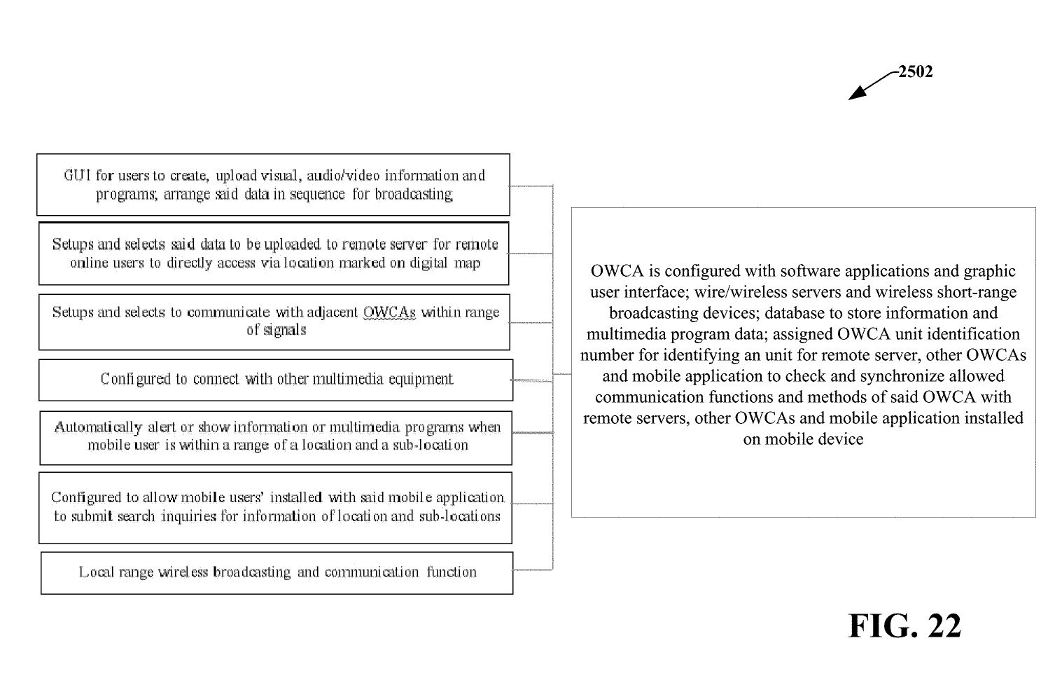

FIGS. 21-22 illustrate exemplary block diagrams of structures and functionalities associated with an OWCA 2502. The OWCA 2502 may comprise various components, hardware devices, software, software in execution, and the like. In embodiments, OWCA 2502 may include a system bus that couples various system components. Such components may include a processing unit(s), system memory device(s), long term storage devices, i/o devices, transceivers and the like. The various components may be employed to perform aspects or embodiments disclosed herein.

The processing unit(s) may comprise various hardware processing devices, such as single-core or multi-core processing devices. Moreover, the processing unit may refer to a “processor,” “controller,” “computing processing unit (CPU),” or the likes. Such terms generally relate to a hardware device. Additionally, the processing unit(s) may include an integrated circuit, an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or the likes.

In embodiments, OWCA 2502 may be utilized as a client and/or a server device. As such, OWCA 2502 may include communication connection(s) for connecting to a communication framework. For instance, communication connection(s) may include cellular antennas, wireless antennas, wired connections, and the likes. Such communication connection(s) may connect to networks via communication framework. The networks may include wide area networks, local area networks, facility or enterprise wide networks (e.g., intranet), global networks (e.g., Internet), satellite networks, and the likes. Some examples of wireless networks include Wi-Fi, Wi-Fi direct, BLUETOOTH™, Zigbee, and other 802.XX wireless technologies. It is noted that communication framework may include multiple networks connected together. For instance, a Wi-Fi network may be connected to a wired Ethernet network.

In an aspect, the communication connection between an OWCA 2502 and a mobile device 2504 may utilize one or more different communication protocols. In at least one embodiment, the OWCA 2502 utilize wireless communication protocols that are generally confined to a particular coverage area such that the OWCA 2502 does not interfere with other OWCA's 2502 and/or is more closely associated with a particular location.

An automated onsite information search and multimedia method and system comprising: software application installed on a mobile device such as a cellphone coupled to internet connection and a web-map such as google map or GPS (Global Position System); a hosting webserver is capable of communicating with said software application and automatically updating location of said software application; and or an onsite wireless communication hosting apparatus with multimedia data hosting, information publishing and broadcasting capacities; said software application is capable of receiving data and signals from said hosting server and or said onsite wireless communication hosting apparatus. An automated onsite information search and multimedia method and system comprising: software application installed on a mobile device such as cellphone; an onsite wireless communication hosting apparatus with multimedia data hosting, information publishing and broadcasting capacities; said software application is capable of receiving data and signals from said onsite wireless communication hosting apparatus. The software application on said mobile device coupled with said web-map or GPS is capable of updating and sending accurate physical location of said mobile device to said hosting webserver. The software application on said mobile device coupled to graphic user interface is capable of submitting a request by user for conditioned information search within a range, postal address and or at location of said mobile device; and displays requested information sent back by said hosting webserver or said onsite wireless communication hosting apparatus according to their actual physical locations and or actual floor layouts within a radius range of said mobile device. Said software application on said mobile device may be deployed on a web browser installed to said mobile device. Said software application on said mobile device is capable of displaying floor layouts within structures of a building, or layout of structures and or functional areas of a facility or an entity. Said hosting webserver is capable of submitting requests to a third-party database via secured access. Said system is capable of accepting oral commands from said user via a microphone installed on said mobile device. Said software application is capable of displaying a selected information and or multimedia programs on popup windows above locked or unlocked screen of said mobile device when said user in, at or close to said business, facility or entity. Said software application is capable of receiving an uniquely assigned digital code to a business; said uniquely assigned digital code is sent out by a signal emitter located within premises of said business, facility or entity; said software application sends said uniquely assigned digital code to its host webserver, said host webserver search any information and or multimedia programs posted and stored in its database by said business, facility or entity and sends back said information and or said multimedia programs to said software application. Said software application is capable of playing a special sound, ringtone or music to alert said user. Said system is capable of making said popup window disappeared from screen of said mobile device when said user walks away and or leaves said business, facility or entity from a close range, and or said assigned digital code signal weakened and replaced by another stronger assigned digital code for another business. Said system is capable of announcing said information via a speaker installed on said mobile device. Said software application is capable of searching and selecting and displaying information from any third party related to selected business, facility or entity posted on websites on screen of said mobile device. Said software application is capable of playing alive or recorded video programs broadcasted by said business, facility or entity. Said software application is capable of allowing user to make a phone call to said business, facility or entity via a touch button displayed on its screen on said mobile device, or via oral command. Said software application is capable of communicating with preconfigured webserver. Said hosting web server and or said onsite wireless communication hosting apparatus are capable of allowing said business, facility or entity to setup a defined physical range from their location to allow its information and or multimedia programs to be activated and give an alert to a user with said mobile device installed with said software application, further activate popup windows and display said information and or multimedia programs. Said software system is capable of playing alive or recorded video and audio announcement simultaneously. Said software system is capable of replacing and or switching between web Pages, windows, multimedia programs. Said hosting server, and or software application installed on said mobile device is capable of calculating effective physical parameter for a location or premises to activate related information and or multimedia programs by comparing and measuring said location to physical distances of other locations. Said software application installed on said mobile device is capable of detecting, and further automatically connecting to and communicating with a hosting server setup for a region and or a country, and further receiving and updating commercials and information from said region and or said country. Said software application installed on said mobile device is capable of identifying a region and or a country and automatically adopting a digital map of said region and or country. Said software application installed on said mobile device is capable of identifying a region and or a country and further displaying and use language of said region and or said country. Said software application is capable of configuring, and or being added to, and or embedded with a software application applied to a mobile device. Said software application coupled with said hosting server and or said onsite wireless communication hosting apparatus is capable of searching location of a specific object, service and or functional area based on map or floor-layout map. Said software application is capable of temporarily disabling ringtone, incoming phone reception and or audio function of said mobile device. Said information and or commercials of a third party may be inserted and displayed, and or played during an onsite alive or recorded video and or audio broadcasting. Said onsite onsite wireless communication hosting apparatus is capable of creating web or window applications, hosting and broadcasting audio and or video programs.

An automated onsite information search and multimedia method and system comprising steps with functions of: a software application coupled with a digital map such as google map or GPS and internet connection installed on a mobile device such as cellphone is capable of communicating with a hosting webserver; said hosting webserver is capable of communicating with said software application and automatically updating location of said software application installed on said mobile device and sending information and or multimedia programs of business, facility or entity at location of said mobile; said hosting webserver is capable of submitting requests to third-party databases via secured access; said software application is capable of accepting oral commands from said user via a microphone installed on said mobile device; said software application is capable of displaying selected information and or playing multimedia programs by said user on popup windows on screen of said mobile device when said user is in, at or close to said business, facility or entity; said system is capable of making said popup window disappeared from screen of said mobile device when said user walks away and or leaves said business, facility or entity from a close range; said software application is capable of playing a special sound, ringtone or music to get alert said user when said selected information and multimedia programs displayed or played on popup windows; said software application is capable of receiving an uniquely assigned digital code to a business; said uniquely assigned digital code is sent out by a signal emitter located within premises of said business; said software application sends said uniquely assigned digital code to its host webserver, said host webserver search commercials from said business from its database and sends back to said software application; said system is capable of announcing said selected information, alive or recorded speech or announcement via a speaker installed on said mobile device; said software application is capable of allowing user to make a phone call to said business, facility or entity via a touch button displayed on screen of said application on said mobile device, or via oral command; said software application is capable of communicating with an onsite wireless communication hosting apparatus; said onsite wireless communication apparatus is capable of composing and publishing information on web pages or windows, and or hosting multimedia data, audio and or video programs, and broadcasting said programs.

Disclosed is an onsite sales and commercial search method and system comprising: a software application installed on a mobile device such as a cellphone coupled to internet connection and a web-map such as google map or GPS (Global Position System); a hosting webserver is capable of communicating with said software application and automatically updating location of said software application and forwarding commercial with a business at location of said mobile device installed with software application; said software application installed on said mobile device is capable of communicating with said hosting webserver and automatically receiving and updating commercial and sales information posted by a business when a user with said mobile device is in, at or visibly close to said business; said mobile device is capable of automatically displaying and updating said commercial and sales information on a business-layout map according to its actual street location, and or actual floor layout of a business when a user of said mobile device is in, at or visibly close to said business. Said software application on said mobile device coupled with said web-map is capable of updating and sending accurate physical location of said mobile device to said hosting webserver. Said software application on said mobile device coupled to graphic user interface is capable of submitting various requests by user on new products and sales information posted online by business and shops within a visible range, postal address and or at location of said mobile device; and displays requested information sent back by said hosting webserver according to a business-layout map according to their actual street locations and or actual floor layouts within a radius range of said mobile device. Said software application on said mobile device may be deployed on a web browser installed to said mobile device. Said software application on said mobile device is capable of displaying floor layouts within structures of a building at a postal address. Said hosting webserver is capable of submitting requests to third-party databases via secured access. Said system is capable of accepting oral commands from said user via a microphone installed on said mobile device. Said software application is capable of displaying a selected business commercial on popup windows on screen of said mobile device when said user in, at or visibly close to said business. Said software application is capable of receiving an uniquely assigned digital code to a business; said uniquely assigned digital code is sent out by a signal emitter located within premises of said business; said software application sends said uniquely assigned digital code to its host webserver, said host webserver search commercials posted and stored in its database by said business and sends back said commercials to said software application. Said software application is capable of playing a special sound, ringtone or music to get attention from said user. Said system is capable of making said popup window disappeared from screen of said mobile device when said user walks away and or leaves said business from a visibly close range, and or said assigned digital code signal weakened and replaced by another stronger assigned digital code for another business. Said system is capable of announcing said selected commercial via a speaker installed on said mobile device. Said software application is capable of searching and selecting and displaying comments on selected business posted on websites on screen of said mobile device. Said software application is capable of playing recorded video clips with commercial of a business. Said software application is capable of allowing user to make a phone call to said business via a touch button displayed on screen of said mobile device, or via oral command. Said software application is capable of communicating with preconfigured webserver only. Said software system is capable of allowing said business to setup a defined physical range from its location to allow its commercial to be activated and get attention from a user with said mobile device installed with said software application, further activate popup windows and display its commercial. Said software system is capable of playing audio announcement or video clip simultaneously, before and or after displaying detailed commercial information on a web page. Said software system is capable of replacing and or switching between web pages, audio announcement and video clip recordings according to different sales and commercial requirements.

Described is an onsite sales and commercial search method and system comprising steps with functions of: a software application coupled with a digital map such as google map or GPS and internet connection installed on a mobile device such as cellphone is capable of communicating with a hosting webserver; said hosting webserver is capable of communicating with said software application and automatically updating location of said software application installed on said mobile device and sending commercial with business at location of said mobile; said commercial information on a business-layout map according to their actual street location and or actual floor layouts when user with said mobile device installed with said software system is in, at or visibly close to said business; said hosting webserver is capable of submitting requests to third-party databases via secured access; said system is capable of accepting oral commands from said user via a microphone installed on said mobile device; said software application is capable of displaying selected business commercial by said user on popup windows on screen of said mobile device when said user is in, at or visible close to said business; said software application is also capable of showing recorded video clips with commercial of said business on said popup window; said system is capable of making said popup window disappeared from screen of said mobile device when said user walks away and or leaves said business from a visibly close range; said software application is capable of playing a special sound, ringtone or music to get attention from said user when said selected business commercial displayed on popup windows; said software application is capable of receiving an uniquely assigned digital code to a business; said uniquely assigned digital code is sent out by a signal emitter located within premises of said business; said software application sends said uniquely assigned digital code to its host webserver, said host webserver search commercials from said business from its database and sends back to said software application; said system is capable of announcing said selected commercial via a speaker installed on said mobile device; said software application is capable of searching and selecting and displaying comments on selected business posted on websites on screen of said mobile device; said software application is capable of allowing user to make a phone call to said business via a touch button displayed on screen of said mobile device, or via oral command.

Described is an onsite sales and commercial search method and system comprising: a software application installed on a mobile device such as a cellphone coupled to internet connection and a web-map such as google map or GPS (Global Position System); a hosting webserver is capable of communicating with said software application and automatically updating location of said software application and forwarding commercial with a business at location of said mobile device installed with software application; said software application installed on said mobile device is capable of communicating with said hosting webserver and automatically receiving and updating commercial and sales information posted by a business when a user with said mobile device is in, at or visibly close to said business; said mobile device is capable of automatically displaying and updating said commercial and sales information on a business-layout map according to its actual street location, and or actual floor layout of a business when a user of said mobile device is in, at or visibly close to said business. Said software application on said mobile device coupled with said web-map is capable of updating and sending accurate physical location of said mobile device to said hosting webserver. Said mobile device coupled to graphic user interface is capable of submitting various requests by user on new products and sales information posted online by business and shops within a visible range, postal address and or at location of said mobile device; and displays requested information sent back by said hosting webserver according to a business-layout map according to their actual street locations and or actual floor layouts within a radius range of said mobile device. Said mobile device may be deployed on a web browser installed to said mobile device. Said software application on said mobile device is capable of displaying floor layouts within structures of a building at a postal address. Said hosting webserver is capable of submitting requests to third-party databases via secured access. Said system is capable of accepting oral commands from said user via a microphone installed on said mobile device. Said software application is capable of displaying a selected business commercial on popup windows on screen of said mobile device when said user in, at or visibly close to said business. Said software application is capable of receiving an uniquely assigned digital code to a business; said uniquely assigned digital code is sent out by a signal emitter located within premises of said business; said software application sends said uniquely assigned digital code to its host webserver, said host webserver search commercials posted and stored in its database by said business and sends back said commercials to said software application. Said software application is capable of playing a special sound, ringtone or music to get attention from said user. Said system is capable of making said popup window disappeared from screen of said mobile device when said user walks away and or leaves said business from a visibly close range, and or said assigned digital code signal weakened and replaced by another stronger assigned digital code for another business. Said system is capable of announcing said selected commercial via a speaker installed on said mobile device. Said software application is capable of searching and selecting and displaying comments on selected business posted on websites on screen of said mobile device. Said software application is capable of playing recorded video clips with commercial of a business. Said software application is capable of allowing user to make a phone call to said business via a touch button displayed on screen of said mobile device, or via oral command. Said software application is capable of communicating with preconfigured webserver only. Said software system is capable of allowing said business to setup a defined physical range from its location to allow its commercial to be activated and get attention from a user with said mobile device installed with said software application, further activate popup windows and display its commercial.

Described is an onsite sales and commercial search method and system comprising steps with functions of: a software application coupled with a digital map such as google map or GPS and internet connection installed on a mobile device such as cellphone is capable of communicating with a hosting webserver; said hosting webserver is capable of communicating with said software application and automatically updating location of said software application installed on said mobile device and sending commercial with business at location of said mobile; said commercial information on a business-layout map according to their actual street location and or actual floor layouts when user with said mobile device installed with said software system is in, at or visibly close to said business; said hosting webserver is capable of submitting requests to third-party databases via secured access; said system is capable of accepting oral commands from said user via a microphone installed on said mobile device; said software application is capable of displaying selected business commercial by said user on popup windows on screen of said mobile device when said user is in, at or visible close to said business; said software application is also capable of showing recorded video clips with commercial of said business on said popup window; said system is capable of making said popup window disappeared from screen of said mobile device when said user walks away and or leaves said business from a visibly close range; said software application is capable of playing a special sound, ringtone or music to get attention from said user when said selected business commercial displayed on popup windows; said software application is capable of receiving an uniquely assigned digital code to a business; said uniquely assigned digital code is sent out by a signal emitter located within premises of said business; said software application sends said uniquely assigned digital code to its host webserver, said host webserver search commercials from said business from its database and sends back to said software application; said system is capable of announcing said selected commercial via a speaker installed on said mobile device; said software application is capable of searching and selecting and displaying comments on selected business posted on websites on screen of said mobile device; said software application is capable of allowing user to make a phone call to said business via a touch button displayed on screen of said mobile device, or via oral command.

Disclosed is a geo-based information provision, search and access system comprising: a software system is configured to allow location owners to submit and post information recorded and live multimedia data via secured accounts over an internet website or UGI (User Graphic Interface) run and administrated by said software system; said information, and recorded and live multimedia data provided by location owners are directly accessible via locations marked on a digital map displayed over end-user interfaces of said internet website; a software application installed on mobile device is configured to communicate with said software system; and said software system is configured to monitor location of said mobile device via a geographical location tracking device; and said mobile device is configured to automatically receive and access said information, recorded and live multimedia data provided by location owners forwarded by said software system via wireless network when said users of said mobile device are in or within a range of said location. Said software system is configured to provide location owners with functions and allow said location owners to select appropriate functions to post information, recorded and live multimedia data on said website. Said software system is configured to allow said location owners to select sequences of information, recorded and live multimedia data; and is configured to automatically display and play the entire information, recorded and live multimedia programs step-by-step automatically by sequences setup by said location owners or by said system. Said software system is configured to allow location owners to select entire or partial information and recorded and live multimedia data displayed or played via said website and or via said application installed on said mobile device. Said software system is configured to show accurate date and time on latest information updated by location owner when internet users move curser of a computer on screen of a monitor over a location marked on said digital map on said internet website run and administrated by said software system. Said software system is configured to show concise information when a location is in the process of broadcasting live audio and video programs as internet users move curser of a computer on screen of a monitor over a location marked on said digital map on said internet website run and administrated by said software system. Said software system is configured to display and show information, recorded and live multimedia programs automatically step-by-step setup by owner of a location when said internet users click on a location marked on said digital map on said internet website run and administrated by said software system. Said software system is configured to allow location owners to setup a password and request internet and mobile device users to enter password to obtain access on information, data, and recorded and live multimedia programs when internet users click on a location on said digital map, or mobile device users are in or within a range of said location. Said software system is configured to reserve a partial screen area when displaying said digital map on said internet website run and administrated by said system; said partial screen area is configured to display information and links of selected online business websites with no physical locations opening to the general public, and within defined searching category submitted via said website to said system by said internet users. Said software system is configured to provide functions and procedures and allow location owners and sub-location owners within physical parameters of said location to create and publish sub-locations marked on said digital map or floor layout within physical range of said location, and further directly provide information and data access to internet and mobile device users.
Disclosed is a geo-based information provision, search and access method comprising steps of: allowing location owners to submit and posting information, recorded and live multimedia data via secured accounts over an internet website or UGI (User Graphic Interface); arranging and step-by-step sequentially showing information, recorded and live multimedia data automatically; showing recorded and live multimedia directly via locations marked on a digital map over internet; and on mobile device, installed with geo position tracking device, via wireless network when user of said mobile device is in or within a range of said location; reserving a partial screen area and displaying information and links of selected online business websites with no physical locations opening to the general public, and within defined searching category submitted via by said users; allowing location owners and sub-location owners within said location to create sub-locations within physical parameters of said locations; publishing and marking their sub-locations on said digital map or floor layout within physical range of said location, and further directly providing information access to internet or mobile device users. Disclosed is a geo-based information provision, search and access system is configured to: allow location owners to submit and posting information, recorded and live multimedia data via secured accounts over an internet website or UGI (User Graphic Interface); arrange and step-by-step sequentially showing information, recorded and live multimedia data automatically; show recorded and live multimedia directly via locations marked on a digital map over internet; and on mobile device, installed with geo position tracking device, via wireless network when user of said mobile device is in or within a range of said location; reserve a partial screen area and displaying information and links of selected online business websites with no physical locations opening to the general public, and within defined searching category submitted via by said users; allow location owners and sub-location owners within said location to create sub-locations within physical parameters of said locations; publish and mark their sub-locations on said digital map or floor layout within physical range of said location, and further directly provide information access to internet or mobile device users.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define the described systems. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Although the embodiments of the present technology have been illustrated in the accompanying drawings and described in the foregoing detailed description, it is to be understood that the present technology is not to be limited to just the embodiments disclosed, but that the technology described herein is capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. An automated onsite information search and multimedia system comprising:
a. software application installed on a mobile device coupled to an internet connection and a geographical positioning device;
b. a remote server communicating with said software application and
c. an onsite wireless communication apparatus configured for:
hosting and storing data and information created or uploaded by owner of said onsite wireless communication apparatus; received via wired or wireless connections; the data and information comprising at least live videos captured via one or more video cameras located within a location, wherein said one or more video cameras are coupled with said onsite wireless communication apparatus via a wired or wireless connection;
creating, publishing, processing information and multimedia programs via a GUI;
communicating data with other multimedia devices; and
broadcasting said information and multimedia programs;
d. wherein said software application is configured for communicating data and signals with at least one of said remote server or said onsite wireless communication apparatus;
e. wherein said remote server and said onsite wireless communication apparatus are configured for communicating data to one another;
f. wherein said onsite wireless communication apparatus generates a unique identification code and transfers said unique identification code to said mobile device;
g. wherein said mobile device transmits said unique identification code to said remote serve, and said remote server determines whether to allow said mobile device to receive other communications from said onsite wireless communication apparatus; and
h. in response to determining to allow said mobile device to receive said other communications, transmitting an instruction to said mobile device to enable said other communications.

2. The automated onsite information search and multimedia system of claim 1, wherein said software application is configured for:
submitting a request by a user for a specific information search within a range, or at a postal address or at said location of said mobile device; and
displaying requested information in response to receiving said requested information from at least one of said remote server or said onsite wireless communication apparatus, based upon at least one of a physical location or actual floor layouts within a range of said location of said mobile device.

3. The automated onsite information search and multimedia system of claim 1, wherein said software application is deployed on a web browser or installed on said mobile device.

4. The automated onsite information search and multimedia system of claim 1, wherein said software application is configured for displaying floor layouts within structures of a building, or layout of structures or functional areas of a facility or an entity.

5. The automated onsite information search and multimedia system of claim 1, wherein said remote server is configured for:
submitting requests to multiple internet web sites or database of a third party via a secured connection; and
optimizing searching results for further process.

6. The automated onsite information search and multimedia system of claim 1, wherein said software application is configured for automatically displaying information or multimedia programs on popup windows above a locked or unlocked screen of said mobile device when said user is within a predefined physical range of said business, facility or entity.

7. The automated onsite information search and multimedia system of claim 6, wherein said software application is configured for playing a special sound, ringtone or announcement to alert said user when said popup windows are displayed.

8. The automated onsite information search and multimedia system of claim 6, wherein said software application is configured for terminating rendering of said popup window from said screen of said mobile device in response to at least one of:
determining that said location of said mobile device leaving from said predefined physical range of said location of said business, facility or entity, or
determining that said assigned digital code signal is weakened and thereby replaced by another stronger digital code signal assigned to another business.

9. The automated onsite information search and multimedia system of claim 6, wherein said system is configured for automatically announcing said information via a speaker installed on said mobile device.

10. The automated onsite information search and multimedia system of claim 6, wherein said software application is configured for searching, selecting and displaying information from any third-party related to said business, facility or entity posted on websites on said screen of said mobile device.

11. The automated onsite information search and multimedia system of claim 6, wherein said software application is configured for temporarily disabling at least one of sound, incoming phone reception or audio function of said mobile device during said playing: of the live or recorded audio and visual onsite performances or games, or activities, or multimedia programs broadcasted by said business, facility or entity.

12. The automated onsite information search and multimedia system of claim 11, wherein said information, said data or multimedia programs of said third-party may be at least one of inserted, displayed, or played with said information, said data and said live or recorded multimedia programs of said business, facility or entity.

13. The automated onsite information search and multimedia system of claim 6, wherein said software application or said remote server or said onsite wireless communication apparatus are configured for calculating timespan of said user staying the predefined physical range of said location of said business, facility or entity in order to determine that said user intends to stay or visit at said location, and is not a passerby.

14. The automated onsite information search and multimedia system of claim 13, wherein said remote server and or said onsite wireless communication apparatus are configured for allowing said business, facility or entity to setup said predefined physical range for said location via web interface or GUI, and allowing said information or multimedia programs to be activated and thereby give an alert to said user via with said mobile device installed on said software application, and further activate the popup windows to display said information or multimedia programs.

15. The automated onsite information search and multimedia system of claim 14, wherein said remote server or software application installed on said mobile device are configured for calculating effective physical parameter for said location or premises associated with the location to activate related information and multimedia programs by comparing and measuring said location to physical distances of other locations.

16. The automated onsite information search and multimedia system of claim 1, wherein said software application installed on said mobile device is configured for detecting and further automatically communicating with a remote server setup for a region or a country, and further receiving and updating information and data from said region or said country.

17. The automated onsite information search and multimedia system of claim 6, wherein said software application coupled with said remote server or said onsite wireless communication apparatus is configured for searching a specific location of at least one of an object, a merchandise, service or a functional area based on at least one of an area, a categorized merchandise, or floor-layout map.

18. The automated onsite information search and multimedia system of claim 1, wherein said onsite wireless communication apparatus is configured for creating and automatically updating information, and broadcasting live or recorded multimedia programs.

19. The automated onsite information search and multimedia system of claim 1, wherein said remote server is configured for issuing and sending authorizations for permits and allowed functions to said onsite wireless communication apparatus; and wherein said remote server is configured for receiving signals sent from said onsite wireless communication apparatus via internet or forwarded via said software application installed on said mobile device, and wherein said remote server further configured for verifying said signals for authorization status for permitted or allowed functions, and wherein said remote server further allowing or rejecting information or multimedia programs displayed or played via said software application installed on said mobile device.

20. The automated onsite information search and multimedia system of claim 1, wherein said onsite wireless communication apparatus is configured for adjusting signals broadcasting range and parameters by scaling up or down strength of said signals.

21. The automated onsite information search and multimedia system of claim 1, wherein said remote server is configured for connecting to a database of a third party via secured access or an internet, and wherein said remote server is further configured for transferring data of specific location requested by said mobile users from said database of said third party or said internet of said third-party, and allowing said data to directly communicate with said software application installed on said mobile device via a connection of said remote server.

22. The automated onsite information search and multimedia system of claim 1, wherein said onsite wireless communication apparatus configures one or more of local servers, wireless routers or wireless signal extenders to extend signal-covering range.

23. The automated onsite information search and multimedia system of claim 1, wherein said software system is configured for playing said live or recorded-videos and audio programs simultaneously.

24. The automated onsite information search and multimedia system of claim 1, wherein said software application is configured to embed a third-party software application or data received from a third party database via secured database access.

25. The automated onsite information search and multimedia system of claim 1, wherein a web application of said software system is configured for allowing location owners to setup a secured account, enter location related information, upload data and multimedia programs, and select a sequence of information and programs to be displayed and played over an interface of a web application of said software system, and an interface of said mobile software application of said software system.

26. The automated onsite information search and multimedia system of claim 1, wherein a web application of said software system is configured for allowing web users to select a location displayed on digital map over interface of said web application, and access information and multimedia programs, wherein said information or media programs are broadcasted or uploaded by said location owners via at least one of a secured connection with said remote hosting server or said onsite wireless communication apparatus in communication with said remote hosting server via a network connection.

27. An automated onsite information search and multimedia system comprising:
a. software application installed on a mobile device;
b. an onsite wireless communication apparatus configured for hosting and storing data and information created or uploaded by owner of said onsite wireless communication apparatus, received via wired or wireless connections, said data and information comprising at least live videos captured via one or more video cameras located within a location, wherein said one or more video cameras are coupled with said onsite wireless communication apparatus via a wired connection, said onsite wireless communication apparatus further configured for creating, publishing, processing information and programs via a GUI (Graphical User Interface), said onsite wireless communication apparatus further configured for transferring/receiving data to/from other multimedia devices and broadcasting said forms of information and programs;
c. said software application configured for communicating and transferring/receiving data and signals to/from said onsite wireless communication apparatus;
d. said onsite wireless communication apparatus is configured for communicating and transferring/receiving data to/from a remote server:
e. said onsite wireless communication apparatus is further configured for sharing data with another onsite wireless communication apparatus coupled to said onsite wireless communication apparatus;
f. wherein said onsite wireless communication apparatus transfers a unique identification code for said wireless communication apparatus to said mobile device;
g. wherein said mobile device forwards said unique identification code to said remote serve, and said remote server determines whether to allow said mobile device to receive other communications from said onsite wireless communication apparatus; and
h. in response to determining to allow said mobile device to receive said other communications, transmitting an instruction to said mobile device to enable said other communications;
i. wherein said onsite wireless communication apparatus is configured for broadcasting information and multimedia program with or without internet connections.

28. An automated onsite information search and multimedia method comprising:
providing a software application installed on a mobile device coupled to internet connection and a geographical positioning device, wherein said software application is in communication with a remote server;
automatically updating, by the remote server, a location of said mobile device;
hosting and storing, by an onsite wireless communication apparatus, data and information created or uploaded by owner of said onsite wireless communication apparatus, received via wired or wireless connections, the data and information comprising at least live videos captured via one or more video cameras located within the location of said mobile device, wherein said one or more video cameras are coupled with said onsite wireless communication apparatus via a wired connection;
creating, publishing, processing, by the onsite wireless communication apparatus, information and multimedia programs via a Graphical User Interface;
transferring/receiving, by the onsite wireless communication apparatus, data to/from other multimedia devices and broadcasting said forms of information and multimedia programs;
transferring/receiving, by the software application, data and signals to/from at least one of the remote server and the onsite wireless communication apparatus;
communicating and transferring, by the remote server, data to the onsite wireless communication apparatus;
communicating and transferring, by the onsite wireless communication apparatus, data to the remote server;
transmitting, by said onsite wireless communication apparatus, a unique identification code to said mobile device;
forwarding, by said mobile device, said unique identification code to said remote serve;
transmitting, by said remote server, a signal identifying whether said onsite wireless communication apparatus is approved for further communications with said mobile device; and
in response to determining to approve said onsite wireless communication apparatus, receiving, by said mobile device, content directly from said onsite wireless communication apparatus.
